(19) United States
(12) Patent Application Publication
(10) Pub. No.: US 2026/0042489 A1
(43) Pub. Date: Feb. 12, 2026

(54) VEHICLE TAILGATE APPARATUS

(71) Applicants: Hyundai Motor Company, Seoul (KR); Kia Corporation, Seoul (KR)

(72) Inventors: Kyu Hoon Cho, Hwaseong-si (KR); Hyung Sik Choi, Hwaseong-si (KR); Joon Bo Shim, Hwaseong-si (KR); Yong Ju Kim, Hwaseong-si (KR)

(21) Appl. No.: 18/926,904

(22) Filed: Oct. 25, 2024

(30) Foreign Application Priority Data
Aug. 9, 2024 (KR) 10-2024-0106935

(51) Int. Cl. B62D 33/037; B60R 16/02; E05C 17/04

(52) U.S. Cl. CPC B62D 33/037; B60R 16/0215; E05C 17/04

(57) ABSTRACT

A vehicle tailgate apparatus can include a tailgate having a main frame configured to move between an open position and a closed position through a pair of bottom hinges at a rear end of a luggage compartment of a vehicle body, and the main frame can include a bottom portion, a first side portion extending from a first end of the bottom portion, and a second side portion extending from a second end of the bottom portion, and the luggage compartment can include a pair of sidewalls and a bed, where each side portion can be aligned with a corresponding sidewall, and where the bottom portion can be aligned with the bed.

### CROSS-REFERENCE TO RELATED APPLICATIONS

This application is based on and claims the benefit of priority to Korean Patent Application No. 10-2024-0106935, filed on Aug. 9, 2024, in the Korean Intellectual Property Office, the disclosure of which is incorporated herein in its entirety by reference.

### TECHNICAL FIELD

The present disclosure relates to a vehicle tailgate apparatus.

### BACKGROUND

A vehicle such as a pickup truck or a sport utility vehicle (SUV) may include a luggage compartment located on a rear portion of a vehicle body, and a tailgate designed to permit access to the luggage compartment. When the tailgate is opened, luggage may be loaded to and unloaded from the luggage compartment. That is, the tailgate is referred to as a door of the luggage compartment.

There are various types of tailgates classified as follows: a traditional tailgate; a drop-down tailgate opening and closing in a drop-down manner; a split tailgate having two doors opening and closing in a swing manner; and a multi-function tailgate opening and closing in various modes.

A width of the tailgate according to the related art may be less than a width of the luggage compartment (or bed) because both side portions thereof are within both sidewalls of the vehicle body. Accordingly, when the tailgate opens in a drop-down manner (that is, the tailgate moves to an open position in which it is unfolded toward the rear of the vehicle), the tailgate may fail to open the entirety of the luggage compartment of the vehicle so that the opening width (opening area) of the luggage compartment may be relatively reduced.

When the doors in the related art split tailgate open in a swing manner, the open position of the doors may be limited to the rear of the vehicle. Because the doors are located at the rear of the vehicle in a state in which the doors are opened, this limitation may be disadvantageous to luggage loading and unloading, trailer connection, a user's movement, and the like. That is, in a state in which the doors of the related art split tailgate are opened, space utilization at the rear of the vehicle may be reduced.

In the related art split tailgate, the two doors may be configured to open and close sequentially, and the two doors may not be allowed to open and close independently. Accordingly, there is a risk of damage to each door if the opening and closing of the two doors is not carried out sequentially.

In addition, the related art tailgate may not be easy to open and close because an open switch thereof may not be intuitive to use.

In the related art split tailgate, a swing path of each door may be relatively large, which is disadvantageous to the opening of the door in a narrow space.

The above information described in this background section is provided to assist in understanding the background of the present disclosure, and may include any information that is not considered as the prior art that is already publicly known, available, or in use.

### SUMMARY

The present disclosure relates to a vehicle tailgate apparatus, and more particularly, to a vehicle tailgate apparatus designed to maximize an opening width (or opening area) of a luggage compartment when a tailgate is opened in a drop-down manner.

An embodiment of the present disclosure can provide a vehicle tailgate apparatus designed to maximize an opening width (or opening area) of a luggage compartment when the tailgate is opened in a drop-down manner.

According to an embodiment of the present disclosure, a vehicle tailgate apparatus may include: a tailgate including a main frame configured to move between an open position and a closed position through a pair of bottom hinges at a rear end of a luggage compartment of a vehicle body. The main frame may include a bottom portion, a first side portion extending from a first end of the bottom portion, and a second side portion extending from a second end of the bottom portion. The luggage compartment may be configured as a pair of sidewalls and a bed, each side portion may be aligned with a corresponding sidewall, and the bottom portion may be aligned with the bed.

An exterior surface of each side portion may be aligned with an exterior surface of the corresponding sidewall.

Both ends of the bottom portion may be pivotally connected to the pair of sidewalls by the pair of bottom hinges, and each bottom hinge may have a horizontal axis extending in a width direction of the vehicle body.

Each bottom hinge may be mounted between a corresponding sidewall of the vehicle body and a corresponding end of the bottom portion, and each bottom hinge may be aligned with a bottom end of a corresponding side portion.

The main frame may include a wiring path therein.

The main frame may further include a first connection member connecting the first end of the bottom portion and a bottom end of the first side portion, and a second connection member connecting the second end of the bottom portion and a bottom end of the second side portion.

The first connection member and the second connection member may be made of a material different from those of the bottom portion, the first side portion, and the second side portion.

The tailgate may further include a pair of doors pivotally connected to the pair of side portions by a plurality of side hinges. The pair of doors may be disposed in an opening defined by the bottom portion, the first side portion, and the second side portion of the main frame.

Each side hinge may include a first vertical axis adjacent to the sidewall of the vehicle body, and a second vertical axis adjacent to each door. The second vertical axis may be parallel to the first vertical axis.

Each door may be configured to move between a closed position, a first open position, and a second open position. The first open position may be a position in which each door is aligned with a corresponding sidewall in a longitudinal direction of the vehicle body, and the second open position may be a position in which each door is folded toward an exterior surface of the corresponding sidewall.

Each side hinge may include a frame-side hinge bracket mounted on each side portion of the main frame, a door-side hinge bracket mounted on each door, and a hinge arm pivotally connected to the frame-side hinge bracket and the door-side hinge bracket.

Each side portion may include a side member, a lower end portion of the side member may be received in an upper receiving portion of a corresponding connection member, and the frame-side hinge bracket of one side hinge of the plurality of side hinges and the upper receiving portion of the connection member may be fixed to the lower end portion of the side member through a fastener.

The vehicle tailgate apparatus may further include a door check mechanism configured to hold each door in the first open position or allow each door to move to the second open position when the door is opened.

The door check mechanism may include: a check strip that is pivotally connected to each side portion of the main frame; and a stopper which is located in the inside of each door, and to which the check strip is releasably coupled.

Each door may have a side opening that is open to the corresponding side portion of the main frame. When each door moves between the closed position, the first open position, and the second open position, the check strip may be received in the inside of each door or be released from the inside of each door.

Each sidewall of the vehicle body may have a recessed portion in which the check strip is received.

The vehicle tailgate apparatus may further include: a frame latch provided on each sidewall of the vehicle body; and a frame striker provided on each side portion of the main frame. The main frame may be locked to and unlocked from the sidewall of the vehicle body by the frame latch and the frame striker.

The vehicle tailgate apparatus may further include a magnetic module and a contact module provided between facing edges of the pair of doors. As the magnetic module generates a magnetic field, the contact module may be attached to the magnetic module, and as the magnetic module blocks the magnetic field, the contact module may not be attached to the magnetic module.

The contact module may include a contact plate attached to the magnetic module by the magnetic field generated by the magnetic module. The contact plate may be configured to move between an attachment position in which the contact plate is attached to the magnetic module and a detachment position in which the contact plate is detached and spaced apart from the magnetic module. The contact plate may be biased to the detachment position by a biasing member.

Each side portion may include a side member having a cavity therein, and a side molding attached to an exterior surface of the side member.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 illustrates a state in which a tailgate is in a closed position in a vehicle tailgate apparatus according to an example embodiment of the present disclosure;

FIG. 2 illustrates a state in which a tailgate is in an open position in a vehicle tailgate apparatus according to an example embodiment of the present disclosure;

FIG. 3 illustrates a state in which a first door and a second door are in a first open position with a main frame of a tailgate in a closed position in a vehicle tailgate apparatus according to an example embodiment of the present disclosure;

FIG. 4 illustrates a state in which a first door and a second door are in a second open position with a main frame of a tailgate in a closed position in a vehicle tailgate apparatus according to an example embodiment of the present disclosure;

FIG. 5 illustrates the deployment of a step mechanism in a state in which a tailgate is in an open position in a vehicle tailgate apparatus according to an example embodiment of the present disclosure;

FIG. 6 illustrates an exploded perspective view of a tailgate in a vehicle tailgate apparatus according to an example embodiment of the present disclosure;

FIG. 7 illustrates an exploded perspective view of a main frame in a vehicle tailgate apparatus according to an example embodiment of the present disclosure;

FIG. 8 illustrates an exploded perspective view of a side portion, a connection member, a cover member, and a bottom portion of a main frame in a vehicle tailgate apparatus according to an example embodiment of the present disclosure;

FIG. 9 illustrates a rear view of a state in which a tailgate is in a closed position in a vehicle tailgate apparatus according to an example embodiment of the present disclosure;

FIG. 10 illustrates a cross-sectional view, taken along line A-A of FIG. 9;

FIG. 11 illustrates a state in which a door check mechanism is mounted on a side portion of a mail frame in a vehicle tailgate apparatus according to an example embodiment of the present disclosure;

FIG. 12 illustrates a cross-sectional view, taken along line B-B of FIG. 9;

FIG. 13 illustrates a state in which a first hinge mount of a first bottom hinge is mounted on a sidewall of a vehicle body in a vehicle tailgate apparatus according to an example embodiment of the present disclosure;

FIG. 14 illustrates a state in which a first hinge socket of a first bottom hinge is mounted on a main frame in a vehicle tailgate apparatus according to an example embodiment of the present disclosure;

FIG. 15 illustrates a state in which a second hinge mount of a second bottom hinge is mounted on a sidewall of a vehicle body in a vehicle tailgate apparatus according to an example embodiment of the present disclosure;

FIG. 16 illustrates a state in which a second hinge shaft of a second bottom hinge is mounted on a main frame in a vehicle tailgate apparatus according to an example embodiment of the present disclosure;

FIG. 17 illustrates a cross-sectional view, taken along line C-C of FIG. 9;

FIG. 18 illustrates a cross-sectional view, taken along line D-D of FIG. 9;

FIG. 19 illustrates a state in which a tailgate is in a closed position in a vehicle tailgate apparatus according to an example embodiment of the present disclosure, which is viewed from the inside of a luggage compartment;

FIG. 20 illustrates a perspective view of a stopper of a door check mechanism of a vehicle tailgate apparatus according to an example embodiment of the present disclosure;

FIG. 21 illustrates a cross-sectional view of a state in which a check strip of a door check mechanism is received in the inside of a door when the door is in a closed position in a vehicle tailgate apparatus according to an example embodiment of the present disclosure;

FIG. 22 illustrates a cross-sectional view of a state in which a hinge arm of a side hinge pivots around a first vertical axis when a door is opened in a vehicle tailgate apparatus according to an example embodiment of the present disclosure;

FIG. 23 illustrates a state in which a check strip is coupled to a stopper when a door is in a first open position in a vehicle tailgate apparatus according to an example embodiment of the present disclosure;

FIG. 24 illustrates a state in which a check strip is released from a stopper when a door pivots from a first open position to a closed position in a vehicle tailgate apparatus according to an example embodiment of the present disclosure;

FIG. 25 illustrates a state in which a check strip is partially released from a door through a side opening of the door when the door pivots toward a closed position in a vehicle tailgate apparatus according to an example embodiment of the present disclosure;

FIG. 26 illustrates a state in which a check strip is completely released from a stopper when a door moves back to a first open position in a vehicle tailgate apparatus according to an example embodiment of the present disclosure;

FIG. 27 illustrates the movement of a door from a first open position to a second open position in a state in which a check strip is completely released from a stopper in a vehicle tailgate apparatus according to an example embodiment of the present disclosure;

FIG. 28 illustrates a state in which a check strip is received in a recessed portion of a sidewall as the check strip is folded to a check bracket in a vehicle tailgate apparatus according to an example embodiment of the present disclosure;

FIG. 29 illustrates a state in which a door moves from a second open position to a first open position in a vehicle tailgate apparatus according to an example embodiment of the present disclosure; and FIG. 30 illustrates a controller and components connected thereto in a vehicle tailgate apparatus according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with the present disclosure can be ruled out to not unnecessarily obscure the gist of the present disclosure.

Terms such as “first,” “second,” “A,” “B,” “(a)”, and “(b)” may be used to describe elements in example embodiments of the present disclosure. Such terms can be used merely to distinguish one element from another element, and the intrinsic features, sequence or order, and the like of the corresponding elements are not necessarily limited by such terms. Unless otherwise defined, terms used herein, including technical or scientific terms, can have a same meanings as those generally understood by those with ordinary knowledge in the field of art to which the present disclosure belongs. Such terms as those defined in a generally used dictionary can be interpreted as having meanings equal to the contextual meanings in the relevant field of art.

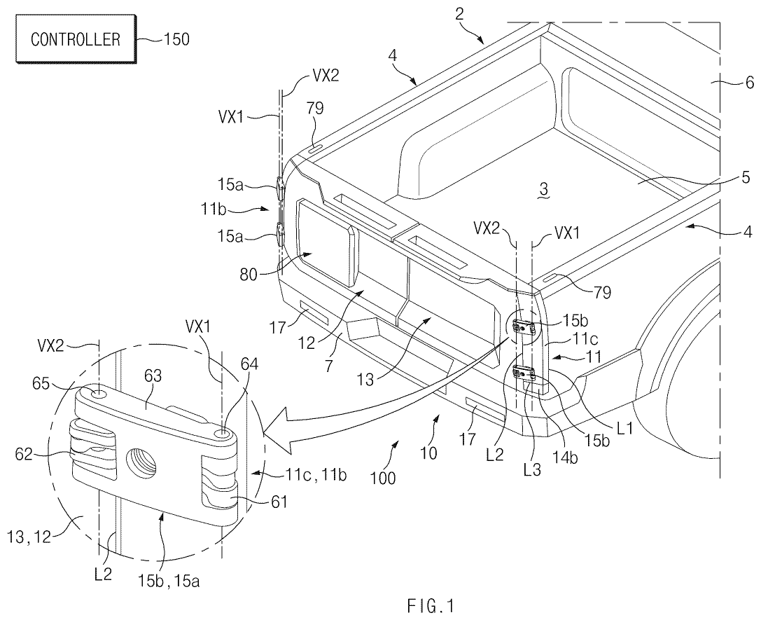

Referring to FIGS. 1 to 4, a vehicle may include a luggage compartment 3 provided on a rear portion of a vehicle body 2. The luggage compartment 3 may be defined by a pair of sidewalls 4 opposing at both rear sides of the vehicle body 2 and a floor or bed 5 located between the pair of sidewalls 4. Each sidewall 4 may be vertically upright at the corresponding rear side of the vehicle body 2, respectively, and the pair of sidewalls 4 may oppose each other in a width direction of the vehicle body 2. The pair of sidewalls 4 may define both side surfaces of the luggage compartment 3, and the bed 5 may define a bottom surface of the luggage compartment 3. Each sidewall 4 may have an interior surface facing the luggage compartment 3, an exterior surface facing the outside of the vehicle body 2, and a rear end surface 4a facing the rear of the vehicle body 2.

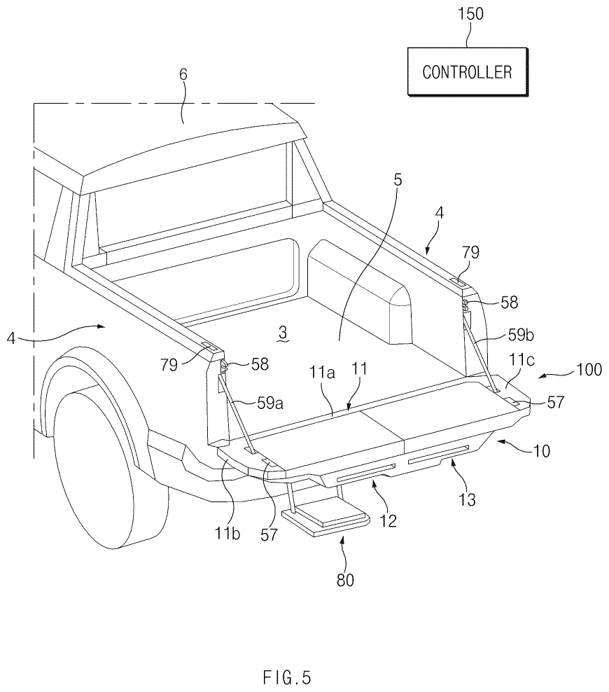

Referring to FIG. 5, a cabin 6 for occupants including a driver may be located on a front portion of the vehicle body 2, and the luggage compartment 3 may be located behind the cabin 6.

Referring to FIGS. 1 to 5, a vehicle tailgate apparatus 100 according to an example embodiment of the present disclosure may be mounted on a rear end of the vehicle body 2. The tailgate apparatus 100 may include a tailgate 10 mounted at a rear end of the luggage compartment 3 to open and close. The tailgate 10 may include a main frame 11 aligned with the pair of sidewalls 4 and the bed 5 of the vehicle body 2. The main frame 11 may be pivotally connected to a rear bottom end of the vehicle body 2 by a pair of bottom hinges 14a and 14b.

The main frame 11 may be a U-shaped frame including a bottom portion 11a aligned with the bed 5 of the vehicle body 2, a pair of side portions 11b and 11c extending from both ends of the bottom portion 11a, and an opening defined by the bottom portion 11a and the pair of side portions 11b and 11c. The pair of side portions 11b and 11c may include a first side portion 11b extending from a first end of the bottom portion 11a, and a second side portion 11c extending from a second end of the bottom portion 11a. A longitudinal axis of the bottom portion 11a may extend in the width direction of the vehicle body 2, and a longitudinal axis of the first side portion 11b may be parallel to a longitudinal axis of the second side portion 11c. The longitudinal axis of each of the side portions 11b and 11c may be perpendicular to the longitudinal axis of the bottom portion 11a.

The side portions 11b and 11c may be aligned with the corresponding sidewalls 4 of the vehicle body 2, respectively. Exterior surfaces of the pair of side portions 11b and 11c may be aligned with the exterior surfaces of the pair of sidewalls 4 of the vehicle body 2, respectively.

The main frame 11 may be pivotally connected to the bed 5 or the sidewalls 4 of the vehicle body 2 through the pair of bottom hinges 14a and 14b, and each of the bottom hinges 14a and 14b may have a horizontal axis HX extending in the width direction of the vehicle body 2. Both ends of the bottom portion 11a of the main frame 11 may be pivotally connected to the pair of sidewalls 4 through the pair of bottom hinges 14a and 14b. The horizontal axis HX of each of the bottom hinges 14a and 14b may be parallel to or be aligned with the longitudinal axis of the bottom portion 11a. As the main frame 11 pivots around the horizontal axis HX of the bottom hinges 14a and 14b, the main frame 11 of the tailgate 10 may move between a closed position (or an upright position) and an open position (or a horizontal position) at the rear end of the vehicle body 2. That is, the tailgate apparatus 100 may operate in a first mode (a drop-down mode). The pair of bottom hinges 14a and 14b may include a first bottom hinge 14a aligned with a bottom end of the first side portion 11b in a longitudinal direction of the first side portion 11b, and a second bottom hinge 14b aligned with a bottom end of the second side portion 11c in a longitudinal direction of the second side portion 11c. The first bottom hinge 14a may be mounted on the first end of the bottom portion 11a and a bottom end of the sidewall 4 corresponding to the first side portion 11b, and the second bottom hinge 14b may be mounted on the second end of the bottom portion 11a and a bottom end of the sidewall 4 corresponding to the second side portion 11c.

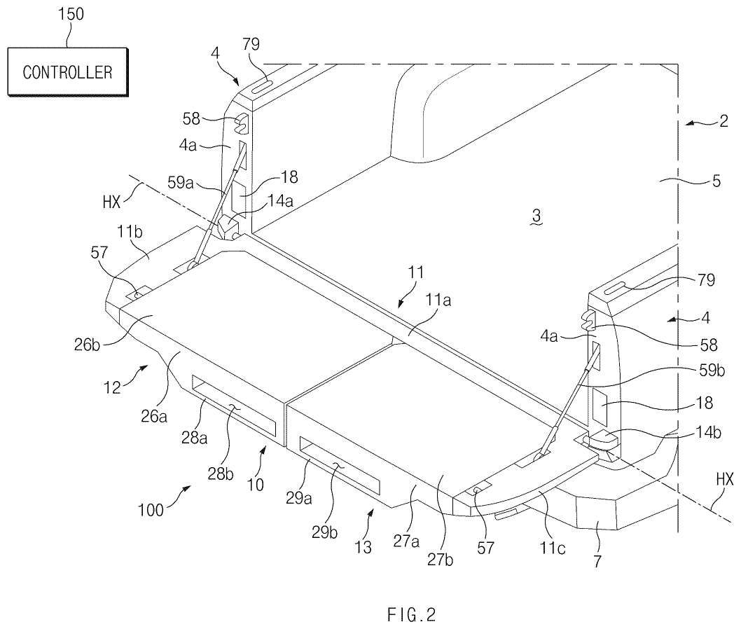

Referring to FIG. 1, the closed position (or the upright position) can refer to a position in which the main frame 11 of the tailgate 10 is folded upward at the rear end of the vehicle body 2. When the tailgate 10 is in the closed position, the rear end of the luggage compartment 3 may be covered by the tailgate 10. Referring to FIG. 2, the open position (or the horizontal position) can refer to a position in which the main frame 11 of the tailgate 10 is folded down toward the rear of the vehicle body 2 at the rear end of the vehicle body 2. When the tailgate 10 is in the open position, an interior surface of the tailgate 10 may be substantially flush with the bed 5 of the vehicle body 2. As the tailgate 10 moves to the open position, the rear end of the luggage compartment 3 may be uncovered. As the main frame 11 of the tailgate 10 moves between the closed position and the open position in a drop-down manner through the bottom hinges 14a and 14b, the tailgate apparatus 100 may operate in the first mode (the drop-down mode). As the tailgate apparatus 100 moves the main frame 11 of the tailgate 10 between the closed position and the open position in the first mode, the tailgate 10 of the tailgate apparatus 100 may serve as a drop-down tailgate.

Each of the side portions 11b and 11c of the main frame 11 may be substantially aligned with the rear end surface 4a of the corresponding sidewall 4 of the vehicle body 2. A distance between the pair of side portions 11b and 11c may be greater than or equal to a distance between the pair of sidewalls 4, and accordingly an opening width of the luggage compartment 3 defined between the sidewalls 4 may be increased.

Referring to FIG. 1, the exterior surface of each of the side portions 11b and 11c may be aligned with the exterior surface of the corresponding sidewall 4 so that a first parting line L1 between each of the side portions 11b and 11c of the main frame 11 and the corresponding sidewall 4 of the vehicle body 2 may extend in a height direction of the vehicle body 2. An interior surface of each of the side portions 11b and 11c may be aligned with the interior surface of the corresponding sidewall 4 or be located at the rear end surface 4a of the corresponding sidewall 4 so that a second parting line L2 between each of the side portions 11b and 11c of the main frame 11 and an outer edge of a corresponding one of doors 12 and 13 may extend in the height direction of the vehicle body 2. The bottom hinges 14a and 14b may be aligned with the bottom ends of the corresponding side portions 11b and 11c so that a third parting line L3 between the bottom ends of the side portions 11b and 11c of the main frame 11 and the corresponding bottom hinges 14a and 14b may extend in the width direction of the vehicle body 2. Accordingly, the bottom portion 11a and the pair of side portions 11b and 11c of the main frame 11 may not interfere with the luggage compartment 3, and thus the width of the main frame 11 may be maximized to correspond to the width of the vehicle body 2, and the width of the luggage compartment 3 may be relatively increased. In particular, when the tailgate 10 is opened in the first mode, the opening width (or opening area) of the luggage compartment 3 may be maximized. In a state in which the tailgate 10 is in the open position, the tailgate 10 may be horizontally aligned with the bed 5 so that the tailgate 10 may be used for various purposes such as a table and/or an extension of the bed 5.

The tailgate apparatus 100 according to an example embodiment of the present disclosure may include a pair of frame latches 58 and a pair of frame strikers 57 provided between the main frame 11 and the vehicle body 2. The pair of frame latches 58 may be provided on the sidewalls 4 of the vehicle body 2, respectively, and the pair of frame strikers 57 may be provided on the side portions 11b and 11c of the main frame 11, respectively. The main frame 11 of the tailgate 10 may be locked to and unlocked from the sidewalls 4 of the vehicle body 2 by the pair of frame latches 58 and the pair of frame strikers 57. As each frame latch 58 can be configured to lock the corresponding frame striker 57, the main frame 11 of the tailgate 10 may be held in the closed position, and as each frame latch 58 unlocks the corresponding frame striker 57, the main frame 11 of the tailgate 10 may be allowed to move.

Referring to FIG. 2, the frame latches 58 may be provided on the corresponding sidewalls 4 of the vehicle body 2, and the frame strikers 57 may be provided on the corresponding side portions 11b and 11c of the main frame 11. With the frame latch 58 is provided on each sidewall 4 of the vehicle body 2, and with the frame striker 57 is provided on each of the side portions 11b and 11c of the main frame 11, the frame latch 58 and the frame striker 57 may be compactly provided between each sidewall 4 of the vehicle body 2 and the corresponding one of the side portions 11b and 11c of the main frame 11, and locking stiffness of the frame latch 58 and the frame striker 57 may be improved. A width of the sidewall 4 of the vehicle body 2 and a width of each of the side portions 11b and 11c of the main frame 11 may be relatively reduced, and the width of the luggage compartment 3 may be relatively increased. Furthermore, when the tailgate 10 is closed, the frame latches 58 and the frame strikers 57 may be not exposed to the outside due to the side portions 11b and 11c of the main frame 11 so that the appearance of the tailgate may be improved.

According to an example embodiment, the frame latch 58 may be a power latch configured to lock and unlock the frame striker 57 with the use of an electric motor. The frame latch 58 may be switched between a partial locked state and a complete locked state by the electric motor. The complete locked state can refer to a state in which the frame latch 58 completely locks the frame striker 57 so that the tailgate 10 may be held in the completely closed position. The complete locked state may be sensed by a first lock sensor provided on the frame latch 58. The partial locked state can refer to a state in which the frame latch 58 partially locks the frame striker 57 so that the tailgate 10 may be held in the partially closed position. The partial locked state may be sensed by a second lock sensor provided on the frame latch 58.

Referring to FIG. 2, when the tailgate 10 is in the open position in the first mode, the tailgate 10 may be supported by a pair of cables 59a and 59b. The cables 59a and 59b may be connected between the corresponding sidewalls 4 and the corresponding side portions 11b and 11c of the main frame 11. Referring to FIGS. 2, 5, and 6, the pair of cables 59a and 59b may include a first cable 59a connected to the first side portion 11b of the main frame 11, and a second cable 59b connected to the second side portion 11c of the main frame 11.

A tailgate 10 according to an example embodiment of the present disclosure may include the pair of doors 12 and 13 pivotally connected to the main frame 11. The pair of doors 12 and 13 may be disposed in the opening of the main frame 11, and the pair of doors 12 and 13 may be pivotally connected to the pair of side portions 11b and 11c of the main frame 11, respectively. Accordingly, the pair of doors 12 and 13 may be allowed to swing in the opening of the main frame 11 through side hinges 15a and 15b.

The pair of doors 12 and 13 may include a first door 12 pivotally connected to the first side portion 11b of the main frame 11 through a first side hinge 15a, and a second door 13 pivotally connected to the second side portion 11c of the main frame 11 through a second side hinge 15b. The first door 12 and the second door 13 may be configured to pivot simultaneously or independently of each other. For example, the first door 12 and the second door 13 may have the same size or different sizes.

The plurality of first side hinges 15a may pivotally connect the first door 12 and the first side portion 11b of the main frame 11, and the plurality of second side hinges 15b may pivotally connect the second door 13 and the second side portion 11c of the main frame 11.

Each of the side hinges 15a and 15b may have a first vertical axis VX1 and a second vertical axis VX2 extending in the height direction of the vehicle body 2. The first vertical axis VX1 may be adjacent to the sidewall 4 of the vehicle body 2, and the second vertical axis VX2 may be adjacent to each of the doors 12 and 13. The second vertical axis VX2 may be parallel to the first vertical axis VX1.

According to an example embodiment, each of the side hinges 15a and 15b may be a double action hinge or a wide angle hinge.

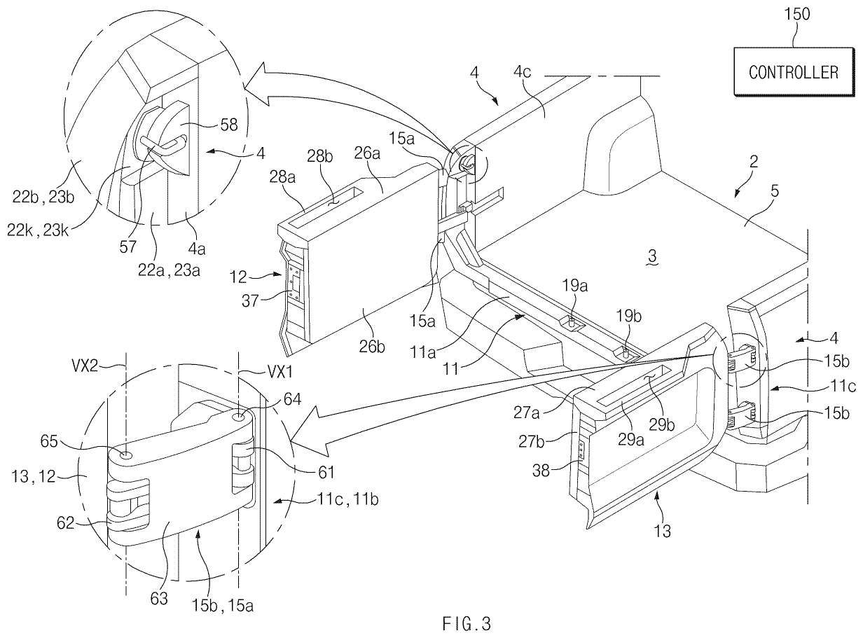

Referring to FIGS. 1 and 3, each of the side hinges 15a and 15b may include a frame-side hinge bracket 61 mounted on each of the side portions 11b and 11c of the main frame 11, a door-side hinge bracket 62 mounted on each of the doors 12 and 13, and a hinge arm 63 pivotally connected to the frame-side hinge bracket 61 and the door-side hinge bracket 62. A first end portion of the hinge arm 63 may be pivotally connected to the frame-side hinge bracket 61 through a first hinge pin 64, and a second end portion of the hinge arm 63 may be pivotally connected to the door-side hinge bracket 62 through a second hinge pin 65. The first vertical axis VX1 may extend along a longitudinal axis of the first hinge pin 64, and the second vertical axis VX2 may extend along a longitudinal axis of the second hinge pin 65.

As the first door 12 pivots around the first vertical axis VX1 of the first side hinge 15a, the first door 12 may move between a closed position (see FIG. 1) and a first open position (see FIG. 3). Referring to FIG. 1, the closed position can refer to a position in which the main frame 11 of the tailgate 10 is in the closed position, and the first door 12 is perpendicular to the sidewall 4 connected thereto. When the first door 12 is in the closed position, one portion of the opening of the main frame 11 may be covered by the first door 12. Referring to FIG. 3, the first open position can refer to a position in which the main frame 11 of the tailgate 10 is in the closed position, and the first door 12 is aligned with the sidewall 4 connected thereto in a longitudinal direction of the vehicle body 2 behind the sidewall 4. When the first door 12 is in the first open position, the first door 12 may open at a first angle (for example, up to 90°) from one portion of the opening of the main frame 11.

As the second door 13 pivots around the first vertical axis VX1 of the second side hinge 15b, the second door 13 may move between a closed position (see FIG. 1) and a first open position (see FIG. 3). Referring to FIG. 1, the closed position can refer to a position in which the main frame 11 of the tailgate 10 is in the closed position, and the second door 13 is perpendicular to the sidewall 4 connected thereto. When the second door 13 is in the closed position, the other portion of the opening of the main frame 11 may be covered by the second door 13. Referring to FIG. 3, the first open position can refer to a position in which the main frame 11 of the tailgate 10 is in the closed position, and the second door 13 is aligned with the sidewall 4 connected thereto in the longitudinal direction of the vehicle body 2 behind the sidewall 4. When the second door 13 is in the first open position, the second door 13 may open at a first angle (for example, up to 90°) from the other portion of the opening of the main frame 11.

As the first door 12 pivots on the first vertical axis VX1 of the first side hinge 15a to move between the closed position and the first open position, and the second door 13 pivots on the first vertical axis VX1 of the second side hinge 15b to move between the closed position and the first open position, the tailgate apparatus 100 may operate in a second mode (a first swing mode).

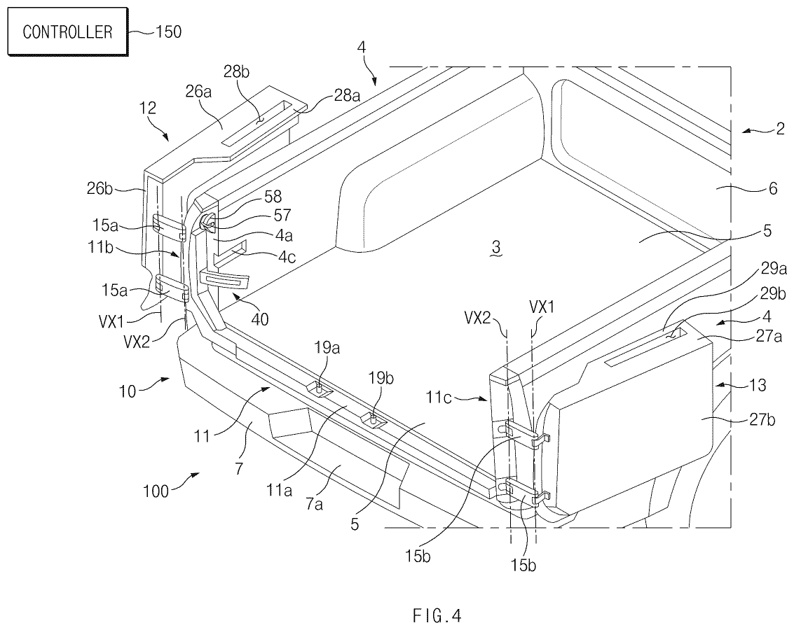

As the first door 12 pivots around the first vertical axis VX1 and the second vertical axis VX2 of the first side hinge 15a, the first door 12 may move between the first open position (see FIG. 3) and a second open position (see FIG. 4). Referring to FIG. 4, the second open position can refer to a position in which the main frame 11 of the tailgate 10 is in the closed position, and the first door 12 is folded toward the exterior surface of the sidewall 4 connected thereto so that the first door 12 may be overlapped with the exterior surface of the sidewall 4 connected thereto. In particular, the first door 12 in the second open position may be substantially parallel to the sidewall 4 connected thereto. When the first door 12 is in the second open position, the first door 12 may open at a second angle (for example, up to 270°) from one portion of the opening of the main frame 11. The second angle can refer to an angle that prevents the first door 12 from interfering with a wheel housing of the sidewall 4. As the first door 12 pivots around the first vertical axis VX1 of the first side hinge 15a, the first door 12 may move from the closed position to the first open position. Thereafter, the hinge arm 63 of the first side hinge 15a may primarily pivot around the first vertical axis VX1 toward the outside of the vehicle body 2. Then, as the first door 12 secondarily pivots around the second vertical axis VX2, the first door 12 may move from the first open position to the second open position.

As the second door 13 pivots around the first vertical axis VX1 and the second vertical axis VX2 of the second side hinge 15b, the second door 13 may move between the first open position (see FIG. 3) and a second open position (see FIG. 4). Referring to FIG. 4, the second open position can refer to a position in which the main frame 11 of the tailgate 10 is in the closed position, and the second door 13 is folded toward the exterior surface of the sidewall 4 connected thereto so that the second door 13 may be overlapped with the exterior surface of the sidewall 4 connected thereto. In particular, the second door 13 in the second open position may be substantially parallel to the sidewall 4 connected thereto. When the second door 13 is in the second open position, the second door 13 may open at a second angle (for example, up to 270°) from the other portion of the opening of the main frame 11. The second angle can refer to an angle that prevents the second door 13 from interfering with a wheel housing of the sidewall 4. As the second door 13 pivots around the first vertical axis VX1 of the second side hinge 15b, the second door 13 may move from the closed position to the first open position. Thereafter, the second side hinge 15b may primarily pivot around the first vertical axis VX1 toward the outside of the vehicle body 2. Then, as the second door 13 secondarily pivots around the second vertical axis VX2 of the second side hinge 15b, the second door 13 may move from the first open position to the second open position.

As the first door 12 pivots on the first vertical axis VX1 and the second vertical axis VX2 of the first side hinge 15a to move between the first open position and the second open position, and the second door 13 pivots on the first vertical axis VX1 and the second vertical axis VX2 of the second side hinge 15b to move between the first open position and the second open position, the tailgate apparatus 100 may operate in a third mode (a second swing mode).

Each of the side hinges 15a and 15b may use the two vertical axes VX1 and VX2 so that each of the doors 12 and 13 may move along an elliptical swing path. Accordingly, the swing path of each of the doors 12 and 13 may be relatively compact, which can facilitate the opening and closing of the doors 12 and 13 in a narrow space. When each of the doors 12 and 13 moves to the second open position, each of the doors 12 and 13 may be overlapped with the exterior surface of the corresponding sidewall 4, and each of the doors 12 and 13 may be not located behind the rear of the vehicle body 2 so that space utilization at the rear of the vehicle may be improved.

As described above, as the tailgate apparatus 100 operates in the second mode (the first swing mode) and the third mode (the second swing mode), the tailgate 10 of the tailgate apparatus 100 may serve as a split tailgate.

Referring to FIG. 1, the vehicle body 2 may have a rear bumper 7 located below the bed 5, and a pair of main lamps 17 may be provided in/on the rear bumper 7. Each main lamp 17 may provide signals for the vehicle's stop, direction change, lane change, the like, or any combination thereof.

Referring to FIG. 2, a pair of auxiliary lamps 18 may be provided on the rear end surfaces 4a of the pair of sidewalls 4. Because the main lamps 17 of the rear bumper 7 can be covered by the tailgate 10 in a state in which the tailgate 10 moves to the open position (or the horizontal position) in the first mode, the pair of auxiliary lamps 18 may provide signals for the vehicle's stop, direction change, lane change, the like, or any combination thereof.

FIGS. 1 to 5 illustrate a pick-up truck to which the tailgate apparatus 100 according to example embodiments of the present disclosure is applied. However, the tailgate apparatus 100 according to example embodiments of the present disclosure may not only be limited to pick-up trucks, but may also be applied to the luggage compartment 3 of various types of vehicles such as a sport utility vehicle (SUV) and/or a van.

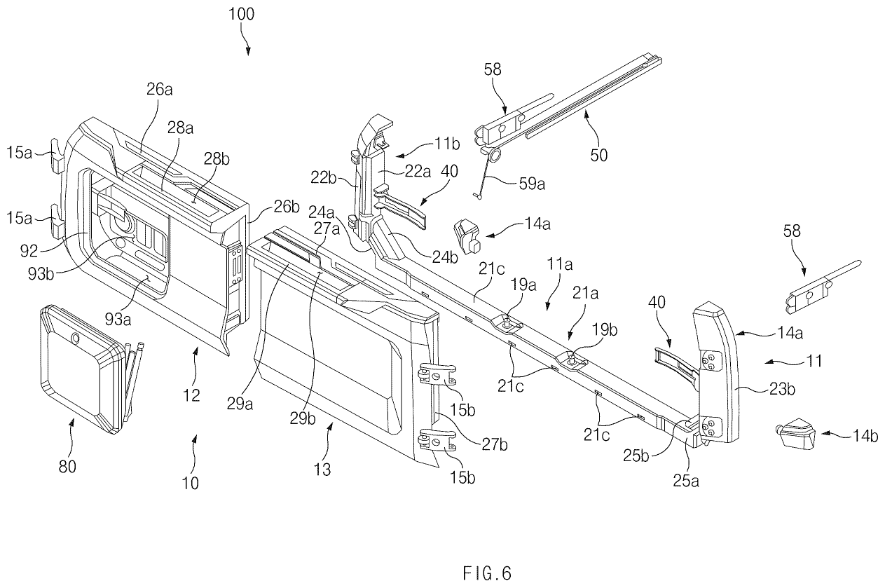

Referring to FIG. 6, the tailgate apparatus 100 according to an example embodiment of the present disclosure may include a drive mechanism 50 configured to move the main frame 11 to the closed position and the open position. The drive mechanism 50 may be disposed in any one of (or both of) the pair of sidewalls 4 to move a corresponding one of the cables 59a and 59b. According to an example embodiment, the drive mechanism 50 may move the first cable 59a in the longitudinal direction of the vehicle so that the main frame 11 may move between the closed position and the open position.

A frame open switch 79 may be provided on a top surface of each sidewall 4, and the frame open switch 79 may be electrically/wirelessly connected to a controller 150. The controller 150 may control the drive mechanism 50 and the frame latches 58, and accordingly the main frame 11 may move between the open position and the closed position by the controller 150. When a user presses the frame open switch 79 to turn on the frame open switch 79, the controller 150 may control the unlocking of the frame latches 58 and the operation of the drive mechanism 50 so that the main frame 11 may move between the open position and the closed position.

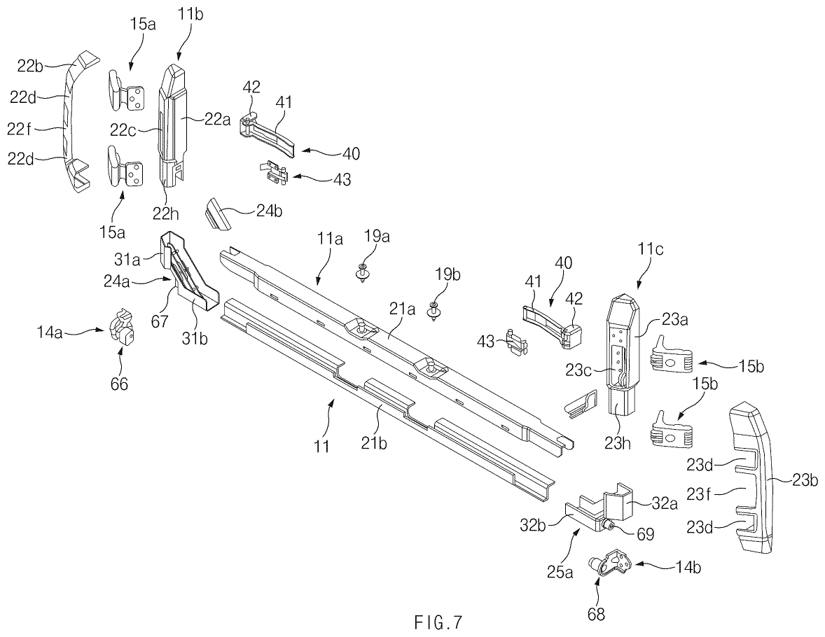

Referring to FIG. 7, the bottom portion 11a may include a bottom member 21a having a cavity that is open downward, and a reinforcing member 21b having a cavity that is open upward. The bottom member 21a and the reinforcing member 21b may extend in a longitudinal direction of the bottom portion 11a.

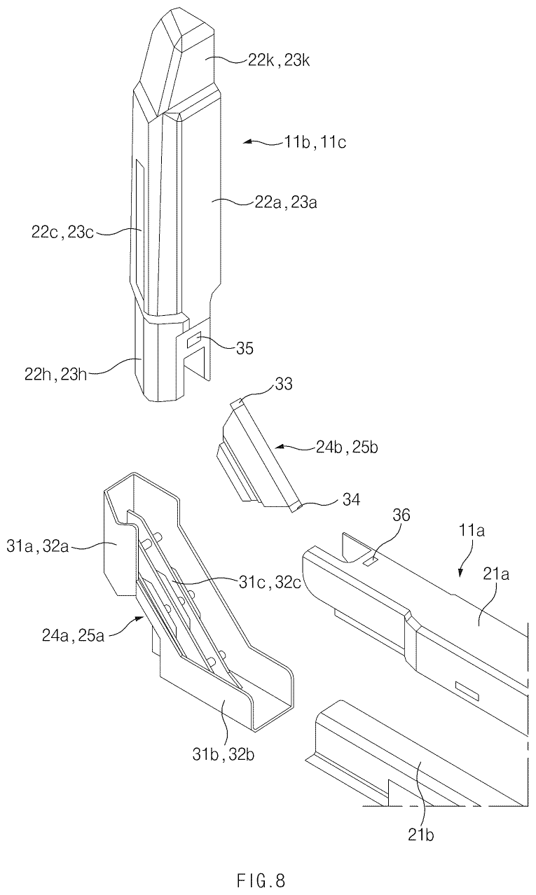

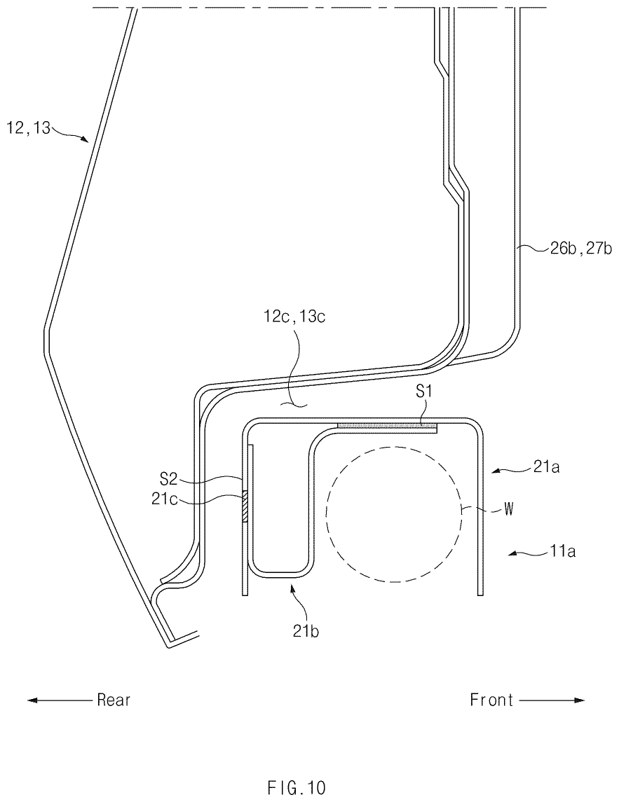

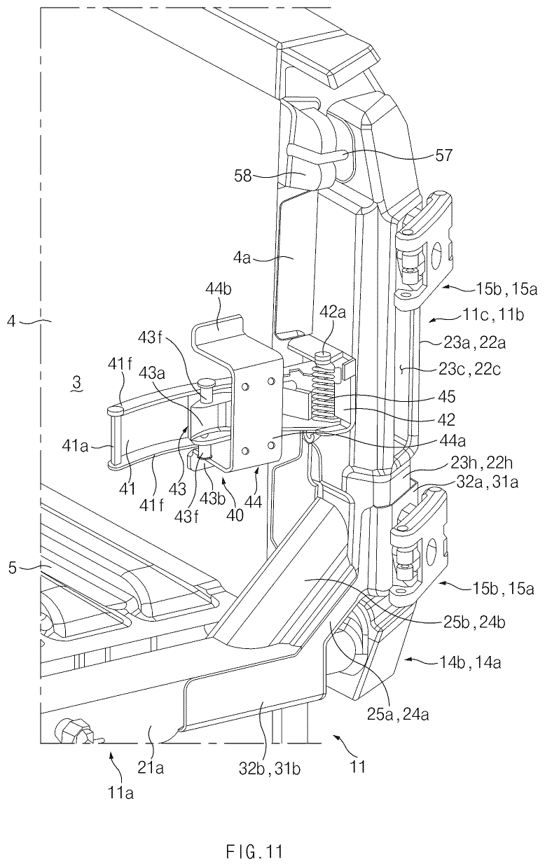

Referring to FIG. 8, the bottom member 21a may have a channel-shaped cross section that is open downward, and the cavity of the bottom member 21a may extend in the longitudinal direction of the bottom portion 11a. The reinforcing member 21b may have a channel-shaped cross section that is open upward, and the cavity of the reinforcing member 21b may extend in the longitudinal direction of the bottom portion 11a. The reinforcing member 21b may be fixed to the bottom member 21a. Referring to FIG. 10, a top wall of the bottom member 21a and a top wall of the reinforcing member 21b may be fixed by a first welded portion S1. For example, the first welded portion S1 may be a spot-welded portion. A rear wall of the bottom member 21a and a rear wall of the reinforcing member 21b may be fixed by a second welded portion S2. For example, the second welded portion S2 may be a plug welded portion or slot welded portion that fixes the rear wall of the bottom member 21a and the rear wall of the reinforcing member 21b through a hole or slot 21c of the bottom member 21a. The reinforcing member 21b may be fixed to the top wall and rear wall of the bottom member 21a in the cavity of the bottom member 21a so that stiffness of the bottom portion 11a may be improved. The bottom member 21a and the reinforcing member 21b may form a space through which a wire loom or wire W can extend within the cavities thereof.

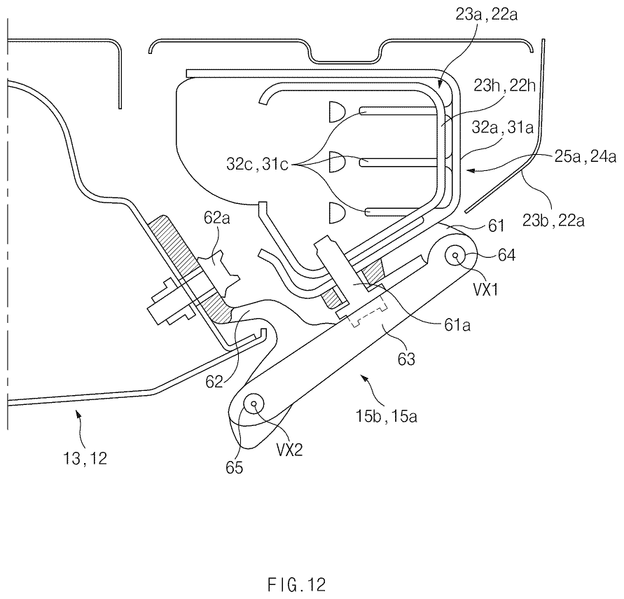

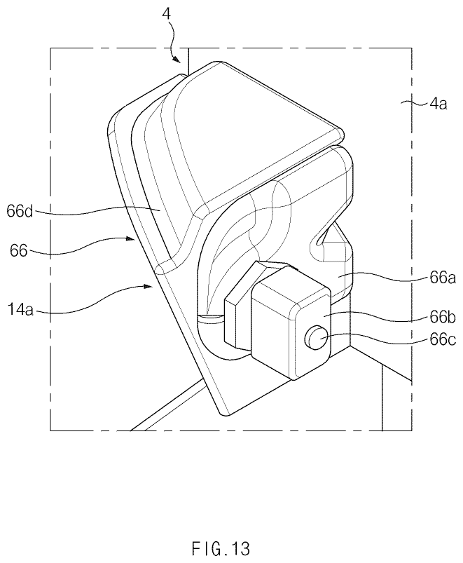

Referring to FIG. 7, the first side portion 11b may include a first side member 22a and a first side molding 22b attached to an exterior surface of the first side member 22a. The first side member 22a may extend in the longitudinal direction of the first side portion 11b, and the first side molding 22b may extend in the longitudinal direction of the first side portion 11b. The first side member 22a may be covered by the first side molding 22b so that the appearance of the first side portion 11b may be improved. The first side molding 22b may have an opening 22d in which a portion (corresponding to the frame-side hinge bracket 61 of FIG. 12) of the first side hinge 15a can be received, and the portion of the first side hinge 15a may be attached to the first side member 22a. According to an example embodiment, portions of two first side hinges 15a may be attached to the first side member 22a, and the first side molding 22b may have two openings 22d in which the portions of the two first side hinges 15a can be received, respectively. The first side member 22a may have a cavity defined therein, and an auxiliary lamp (not shown) may be embedded in the cavity of the first side member 22a. The first side member 22a may have an opening 22c communicating with the cavity thereof. The first side molding 22b may have an opening 22f aligned with the opening 22c of the first side member 22a. The auxiliary lamp embedded in the cavity of the first side member 22a may be exposed to the outside through the opening 22c of the first side member 22a and the opening 22f of the first side molding 22b.

Referring to FIG. 7, the second side portion 11c may include a second side member 23a and a second side molding 23b attached to an exterior surface of the second side member 23a. The second side member 23a may extend in the longitudinal direction of the second side portion 11c, and the second side molding 23b may extend in the longitudinal direction of the second side portion 11c. The second side member 23a may be covered by the second side molding 23b so that the appearance of the second side portion 11c may be improved. The second side molding 23b may have an opening 23d in which a portion (corresponding to the frame-side hinge bracket 61 of FIG. 12) of the second side hinge 15b can be received, and the portion of the second side hinge 15b may be attached to the second side member 23a. According to an example embodiment, portions of two second side hinges 15b may be attached to the second side member 23a, and the second side molding 23b may have two openings 23d in which the portions of the two second side hinges 15b can be received, respectively. The second side member 23a may have a cavity defined therein, and an auxiliary lamp (not shown) may be embedded in the cavity of the second side member 23a. The second side member 23a may have an opening 23c communicating with the cavity thereof. The second side molding 23b may have an opening 23f aligned with the opening 23c of the second side member 23a. The auxiliary lamp embedded in the cavity of the second side member 23a may be exposed to the outside through the opening 23c of the second side member 23a and the opening 23f of the second side molding 23b.

Referring to FIGS. 3 and 8, the first side member 22a may have a recessed portion 22k provided in an upper portion thereof, and the second side member 23a may have a recessed portion 23k provided in an upper portion thereof. Referring to FIG. 3, the frame strikers 57 may be mounted on the recessed portions 22k and 23k of the corresponding side members 22a and 23a, respectively. When the doors 12 and 13 are opened and closed, the recessed portions 22k and 23k may prevent the doors 12 and 13 from interfering with the frame strikers 57.

Referring to FIGS. 6 and 7, the main frame 11 may include a pair of connection members 24a and 25a connecting the pair of side portions 11b and 11c to both ends of the bottom portion 11a, respectively. The pair of connection members 24a and 25a may include a first connection member 24a connecting the first side portion 11b and the first end of the bottom portion 11a, and a second connection member 25a connecting the second side portion 11c and the second end of the bottom portion 11a.

The first connection member 24a may be configured to connect the bottom member 21a of the bottom portion 11a and the first side member 22a of the first side portion 11b. The first connection member 24a may be inclined at a predetermined angle between the bottom end of the first side portion 11b and the first end of the bottom portion 11a, and the first connection member 24a may have a plurality of ribs 31c provided therein so that stiffness of the first connection member 24a may be improved.

The first connection member 24a may have an upper receiving portion 31a in which a lower end portion 22h of the first side member 22a is received, and a lower receiving portion 31b in which a first end portion of the bottom member 21a is received. The upper receiving portion 31a of the first connection member 24a may have a shape and a size corresponding to those of the lower end portion 22h of the first side member 22a, and the lower receiving portion 31b of the first connection member 24a may have a shape and a size corresponding to those of the first end portion of the bottom member 21a. The upper receiving portion 31a of the first connection member 24a and the lower end portion 22h of the first side member 22a may be joined by a plurality of fasteners, and the lower receiving portion 31b of the first connection member 24a and the first end portion of the bottom member 21a may be joined by a plurality of fasteners.

The first connection member 24a may be made of a material different from that of the first side member 22a and the bottom member 21a. The stiffness of the first connection member 24a may be similar to stiffness of the first side member 22a and stiffness of the bottom member 21a, and a weight of the first connection member 24a may be less than a weight of the first side member 22a and a weight of the bottom member 21a. According to an example embodiment, the first connection member 24a may be made of an aluminum material, and the first side member 22a and the bottom member 21a may be made of a steel material. The first connection member 24a may be an aluminum die-cast component manufactured by a die-casting method. The first connection member 24a, the first side member 22a, and the bottom member 21a made of different materials may be firmly connected through the fasteners.

The second connection member 25a may be configured to connect the bottom member 21a of the bottom portion 11a and the second side member 23a of the second side portion 11c. The second connection member 25a may be inclined at a predetermined angle between the bottom end of the second side portion 11c and the second end of the bottom portion 11a, and the second connection member 25a may have a plurality of ribs 32c provided therein so that stiffness of the second connection member 25a may be improved.

The second connection member 25a may include an upper receiving portion 32a in which a lower end portion 23h of the second side member 23a is received, and a lower receiving portion 32b in which a second end portion of the bottom member 21a is received. The upper receiving portion 32a of the second connection member 25a may have a shape and a size corresponding to those of the lower end portion 23h of the second side member 23a, and the lower receiving portion 32b of the second connection member 25a may have a shape and a size corresponding to those of the second end portion of the bottom member 21a. The upper receiving portion 32a of the second connection member 25a and the lower end portion 23h of the second side member 23a may be joined by a plurality of fasteners, and the lower receiving portion 32b of the second connection member 25a and the second end portion of the bottom member 21a may be joined by a plurality of fasteners.

The second connection member 25a may be made of a material different from that of the second side member 23a and the bottom member 21a. The stiffness of the second connection member 25a may be similar to stiffness of the second side member 23a and stiffness of the bottom member 21a, and a weight of the second connection member 25a may be less than a weight of the second side member 23a and a weight of the bottom member 21a. According to an example embodiment, the second connection member 25a may be made of an aluminum material, and the second side member 23a and the bottom member 21a may be made of a steel material. The second connection member 25a may be an aluminum die-cast component manufactured by a die-casting method. The second connection member 25a, the second side member 23a, and the bottom member 21a made of different materials may be firmly connected through the fasteners.

The first connection member 24a may have a cavity which is open upward, and the cavity of the first connection member 24a may communicate with the cavity of the first side member 22a and the cavity of the bottom member 21a. The second connection member 25a may have a cavity which is open upward, and the cavity of the second connection member 25a may communicate with the cavity of the second side member 23a and the cavity of the bottom member 21a. Accordingly, the cavity of the first side portion 11b, the cavity of the bottom portion 11a, and the cavity of the second side portion 11c may communicate with each other so that the wire may extend through the cavity of the first side portion 11b, the cavity of the bottom portion 11a, and the cavity of the second side portion 11c, and the wire may be electrically connected to the auxiliary lamps embedded in the first side member 22a and the second side member 23a. That is, the main frame 11 may include a wiring path defined therein.

The main frame 11 may include a pair of cover members 24b and 25b covering the pair of connection members 24a and 25a, respectively. The pair of cover members 24b and 25b may include a first cover member 24b covering the top of the first connection member 24a, and a second cover member 25b covering the top of the second connection member 25a.

Referring to FIG. 8, the cover members 24b and 25b may extend obliquely at an angle corresponding to that of the corresponding connection members 24a and 25a. Each of the cover members 24b and 25b may include an upper projection 33 protruding to the corresponding one of the side members 22a and 23a, and a lower projection 34 extending toward the corresponding end portion of the bottom member 21a. Each of the side members 22a and 23a may have a hole 35 in which the upper projection 33 is received, and each end portion of the bottom member 21a may have a hole 36 in which the lower projection 34 is received. Accordingly, the upper projection 33 of each of the cover members 24b and 25b may be inserted into the hole 35 of the corresponding one of the side members 22a and 23a, and the lower projection 34 of each of the cover members 24b and 25b may be inserted into the hole 36 of the corresponding end portion of the bottom member 21a so that the cover members 24b and 25b may be temporarily joined between the corresponding side members 22a and 23a and the corresponding end portions of the bottom member 21a. Upper and lower end portions of the cover members 24b and 25b temporarily joined may be fixed to the corresponding side members 22a and 23a and the corresponding end portions of the bottom member 21a by CO₂ welding and/or the like.

Referring to FIG. 10, the doors 12 and 13 may have recessed portions 12c and 13c provided in lower end portions thereof, respectively. When the doors 12 and 13 are closed, the bottom portion 11a of the main frame 11 may be received in the recessed portions 12c and 13c of the doors 12 and 13, and accordingly the bottom portion 11a of the main frame 11 may be covered by the lower end portions of the doors 12 and 13.

The tailgate apparatus 100 according to an example embodiment of the present disclosure may include a pair of lower latches and a pair of lower strikers 19a and 19b provided between the lower end portions of the doors 12 and 13 and the main frame 11, respectively. A first lower latch may be provided on the lower end portion of the first door 12, and a first lower striker 19a may be provided on the bottom portion 11a of the main frame 11. The first lower latch may lock the first lower striker 19a so that the first door 12 may be held in the closed position, and the first lower latch may unlock the first lower striker 19a so that the first door 12 may be allowed to open. A second lower latch may be provided on the lower end portion of the second door 13, and a second lower striker 19b may be provided on the bottom portion 11a of the main frame 11. The second lower latch may lock the second lower striker 19b so that the second door 13 may be held in the closed position, and the second lower latch may unlock the second lower striker 19b so that the second door 13 may be allowed to open. Referring to FIGS. 6 and 7, the first lower striker 19a and the second lower striker 19b may be symmetrical to each other on the basis of the center of the bottom portion 11a of the main frame 11.

The first bottom hinge 14a may include a first hinge mount 66 provided on the vehicle body 2, and a first hinge socket 67 provided on the main frame 11.

Referring to FIG. 13, the first hinge mount 66 may include a first bracket 66a fixed to a bottom end of the rear end surface 4a of the corresponding sidewall 4 (corresponding to the left sidewall of FIG. 2) of the vehicle body 2, a first hinge shaft 66b rotatably mounted on the first bracket 66a through a pin 66c, and a first hinge cover 66d covering the first bracket 66a. The first hinge shaft 66b may have a hexahedral shape.

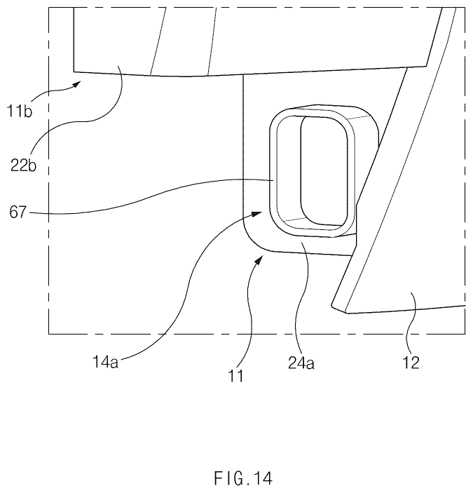

Referring to FIG. 14, the first hinge socket 67 may be provided on the first connection member 24a of the main frame 11. The first hinge socket 67 may be configured to receive the first hinge shaft 66b of the first hinge mount 66. The first hinge socket 67 may be a hexahedral socket having a shape and a size corresponding to those of the first hinge shaft 66b.

A longitudinal axis of the first hinge shaft 66b and a longitudinal axis of the first hinge socket 67 may be aligned with the horizontal axis HX (see FIG. 2).

The second bottom hinge 14b may include a second hinge mount 68 provided on the vehicle body 2, and a second hinge shaft 69 provided on the main frame 11.

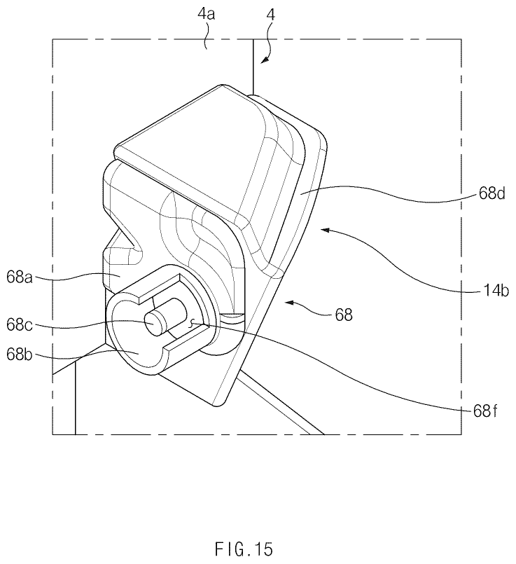

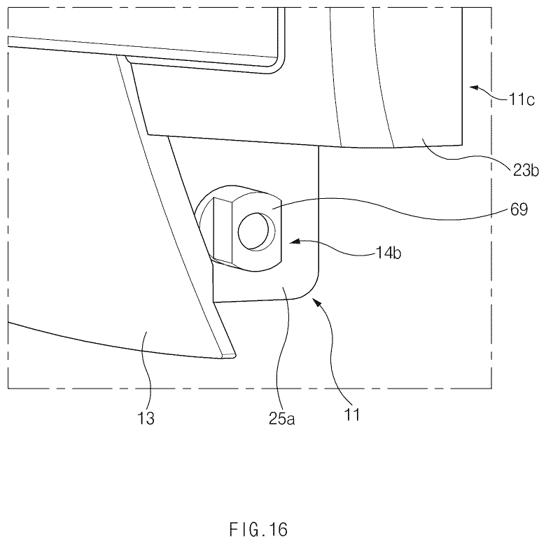

Referring to FIG. 15, the second hinge mount 68 may include a second bracket 68a fixed to a bottom end of the rear end surface 4a of the corresponding sidewall 4 (corresponding to the right sidewall of FIG. 2) of the vehicle body 2, a second hinge socket 68b fixed to the second bracket 68a through a fastener 68c, and a second hinge cover 68d covering the second bracket 68a. The second hinge socket 68b may have a hollow cylindrical shape with an opening 68f.

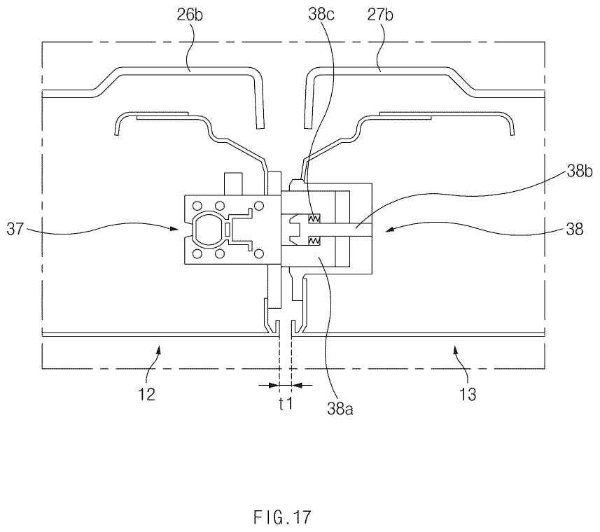

Referring to FIG. 16, the second hinge shaft 69 may be provided on the second connection member 25a of the main frame 11. The second hinge shaft 69 may be received in the second hinge socket 68b of the second hinge mount 68. The second hinge shaft 69 may have a solid cylindrical shape having an outer diameter less than an inner diameter of the second hinge socket 68b, and the second hinge shaft 69 may have a pair of opposing flat surfaces.

A longitudinal axis of the second hinge socket 68b and a longitudinal axis of the second hinge shaft 69 may be aligned with the horizontal axis HX (see FIG. 2).

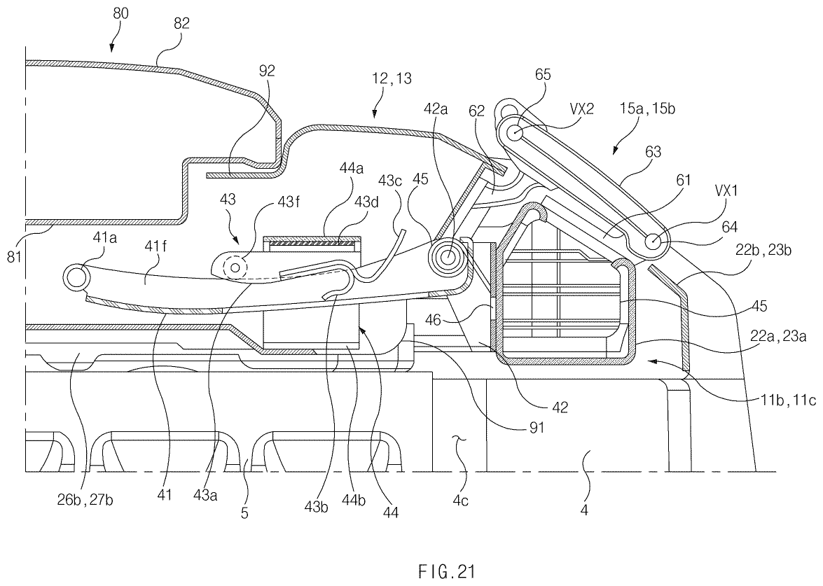

Referring to FIG. 11, of the two first side hinges 15a, an upper first side hinge 15a may be connected to the first side member 22a, and a lower first side hinge 15a may be connected to the upper receiving portion 31a of the first connection member 24a. Referring to FIG. 21, the frame-side hinge bracket 61 of the upper first side hinge 15a may be fixed to the first side member 22a of the first side portion 11b through a fastener. Referring to FIG. 12, the frame-side hinge bracket 61 of the lower first side hinge 15a together with the upper receiving portion 31a of the first connection member 24a may be fixed to the lower end portion 22h of the first side member 22a through a fastener 61a.

Referring to FIG. 11, of the two second side hinges 15b, an upper second side hinge 15b may be connected to the second side member 23a, and a lower second side hinge 15b may be connected to the upper receiving portion 32a of the second connection member 25a. Referring to FIG. 21, the frame-side hinge bracket 61 of the upper second side hinge 15b may be fixed to the second side member 23a of the second side portion 11c through a fastener. Referring to FIG. 12, the frame-side hinge bracket 61 of the lower second side hinge 15b together with the upper receiving portion 32a of the second connection member 25a may be fixed to the lower end portion 23h of the second side member 23a through a fastener 61a.

The first door 12 may include an interior surface facing the luggage compartment 3, and an exterior surface facing the outside of the vehicle body 2.

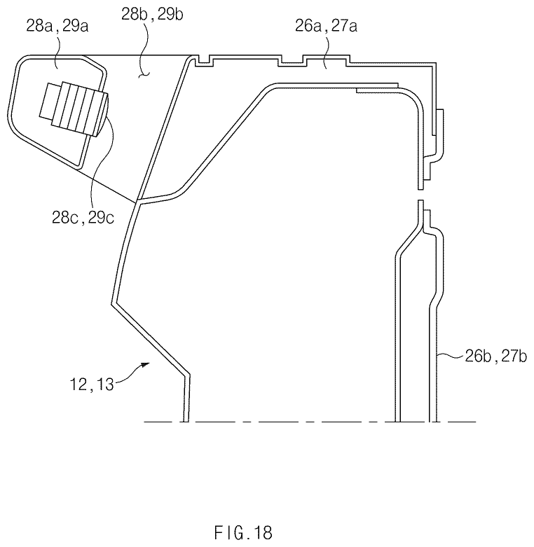

The interior surface of the first door 12 may face the front of the vehicle, and the exterior surface of the first door 12 may face the rear of the vehicle. Referring to FIGS. 6 and 18, the tailgate 10 according to an example embodiment of the present disclosure may include a first upper trim 26a attached to a top surface of the first door 12, and a first interior trim 26b detachably attached to the interior surface of the first door 12. The first upper trim 26a may have a first door grip 28a, and the first door grip 28a may have a first grip aperture 28b. The first grip aperture 28b may be formed between the first door grip 28a and the first upper trim 26a.

The second door 13 may include an interior surface facing the luggage compartment 3, and an exterior surface facing the outside of the vehicle body 2.

The interior surface of the second door 13 may face the front of the vehicle, and the exterior surface of the second door 13 may face the rear of the vehicle.

Referring to FIGS. 6 and 18, the tailgate 10 according to an example embodiment of the present disclosure may include a second upper trim 27a attached to a top surface of the second door 13, and a second interior trim 27b detachably attached to the interior surface of the second door 13. The second upper trim 27a may have a second door grip 29a, and the second door grip 29a may have a second grip aperture 29b. The second grip aperture 29b may be formed between the second door grip 29a and the second upper trim 27a.

Referring to FIG. 18, a first door open switch 28c may be provided on the first door grip 28a, and the first door open switch 28c may be electrically connected to the first lower latch. A second door open switch 29c may be provided on the second door grip 29a, and the second door open switch 29c may be electrically connected to the second lower latch.

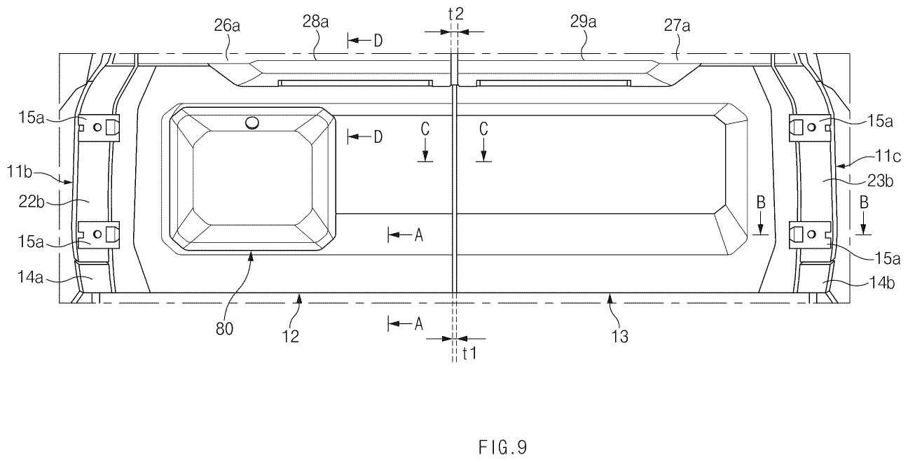

The first door 12 may include a first hinge-side edge hingeably connected to the first side portion 11b of the main frame 11 by the first side hinge 15a, and a first door-side edge facing the second door 13. The second door 13 may include a second hinge-side edge hingeably connected to the second side portion 11c of the main frame 11 by the second side hinge 15b, and a second door-side edge facing the first door 12. Referring to FIG. 9, in a state in which the first door 12 and the second door 13 are closed, the first door-side edge of the first door 12 and the second door-side edge of the second door 13 may be spaced apart from each other by a first gap t1, and a first door-side edge of the first upper trim 26a and a second door-side edge of the second upper trim 27a may be spaced apart from each other by a second gap t2. The first gap t1 may allow the first door 12 and the second door 13 not to interfere with each other when the first door 12 and the second door 13 are individually opened or simultaneously opened. The second gap t2 may be greater than the first gap t1.

The tailgate apparatus 100 according to an example embodiment of the present disclosure may further include a magnetic module 37 and a contact module 38 provided between the facing edges of the first door 12 and the second door 13. The magnetic module 37 may be configured to generate and block a magnetic field. As the magnetic module 37 generates the magnetic field, the contact module 38 may be attached to the magnetic module 37 by a magnetic force, and accordingly the magnetic module 37 may lock the contact module 38. As the magnetic module 37 blocks the magnetic field, the contact module 38 may not be attached to the magnetic module 37, and accordingly the magnetic module 37 may unlock the contact module 38. That is, the magnetic module 37 may be configured to lock and unlock the contact module 38 by the generation and blockage of the magnetic field, and the first door 12 and the second door 13 may be locked to and unlocked from each other by the magnetic module 37 and the contact module 38.

According to an example embodiment, the magnetic module 37 may be provided at the edge of the first door 12, and the contact module 38 may be provided at the edge of the second door 13. According to another example embodiment, the magnetic module 37 may be provided at the edge of the second door 13, and the contact module 38 may be provided at the edge of the first door 12.

The magnetic module 37 may be electrically connected to the first door open switch 28c and the second door open switch 29c. As the magnetic module 37 is turned on, the magnetic module 37 may generate the magnetic field, and the contact module 38 may be attached to the magnetic module 37 by the magnetic force so that the magnetic module 37 may lock the contact module 38. As the magnetic module 37 is turned off, the magnetic module 37 may block the magnetic field, and the contact module 38 may not be attached to the magnetic module 37 so that the magnetic module 37 may unlock the contact module 38.

According to an example embodiment, the magnetic module 37 may be a switchable magnetic device including a fixed magnet, a rotating magnet which is rotatable with respect to the fixed magnet, and an actuator which rotates the rotating magnet.

According to another example embodiment, the magnetic module 37 may be an electromagnet.

Referring to FIG. 17, the magnetic module 37 may be mounted on the first door-side edge of the first door 12, and the contact module 38 may be mounted on the second door-side edge of the second door 13. The contact module 38 may include a contact plate 38a made of a magnetic material, and the contact plate 38a may be configured to be movable with respect to the magnetic module 37. The contact plate 38a may be configured to move between an attachment position in which the contact plate 38a is attached to the magnetic module 37 and a detachment position in which the contact plate 38a is detached and spaced apart from the magnetic module 37 by the first gap t1 or greater. The contact module 38 may further include a guide pin 38b configured to guide the movement of the contact plate 38a. The guide pin 38b may be fixed to the second door 13, and the contact plate 38a may be configured to move along the guide pin 38b. The contact module 38 may further include a biasing member 38c allowing the contact plate 38a to be biased so that the contact plate 38a may be spaced apart from the magnetic module 37 by the first gap t1 or greater. The biasing member 38c may be a coil spring provided around the guide pin 38b. When the magnetic module 37 blocks the magnetic field, the contact plate 38a may be biased by the biasing member 38c to be spaced apart from the magnetic module 37 by the first gap t1 or greater.

As the magnetic module 37 is turned on, the magnetic module 37 may generate the magnetic field, and the contact module 38 may be attached to the magnetic module 37 by the magnetic force, and accordingly the first door 12 and the second door 13 may be locked to each other, and the first door 12 and the second door 13 may be held in the closed position.

As the magnetic module 37 is turned off, the magnetic module 37 may block the magnetic field, and the contact module 38 may not be attached to the magnetic module 37, and accordingly the first door 12 and the second door 13 may be unlocked from each other. In particular, the contact plate 38a of the contact module 38 may be biased by the biasing member 38c to be spaced apart from the magnetic module 37 by the first gap t1 or greater so that a rotation gap between the first door 12 and the second door 13 may be sufficiently secured, and the first door 12 and the second door 13 may be individually opened or simultaneously opened without interfering with each other.

Referring to FIG. 6, the tailgate apparatus 100 according to an example embodiment of the present disclosure may include a pair of door check mechanisms 40 connected to the pair of side portions 11b and 11c of the main frame 11, respectively. The door check mechanisms 40 may be configured to hold the corresponding doors 12 and 13 in predetermined positions, respectively, when the doors 12 and 13 are opened and closed. Specifically, the door check mechanisms 40 may be configured to hold the doors 12 and 13 in the first open position or allow the doors 12 and 13 to move to the second open position when the doors 12 and 13 are opened.

Referring to FIG. 11, each door check mechanism 40 may include a check strip 41 pivotally connected to each of the side portions 11b and 11c of the main frame 11, and a stopper 43 to which the check strip 41 can be releasably coupled.

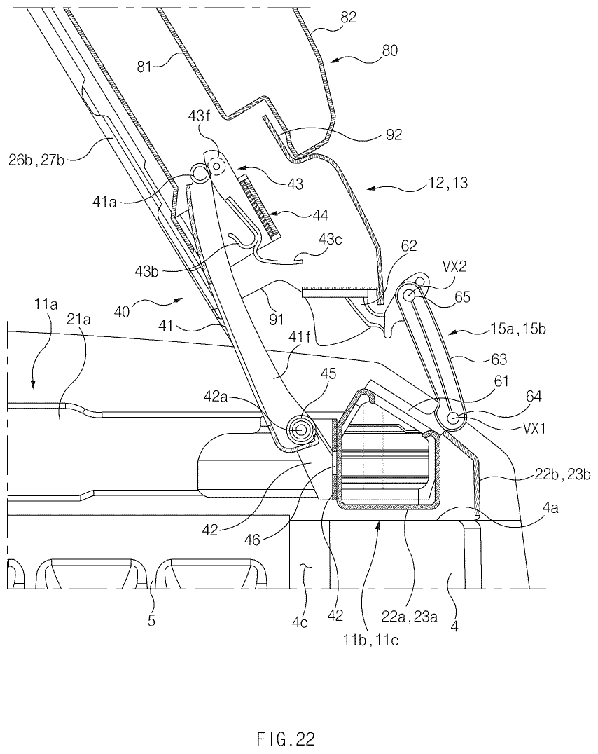

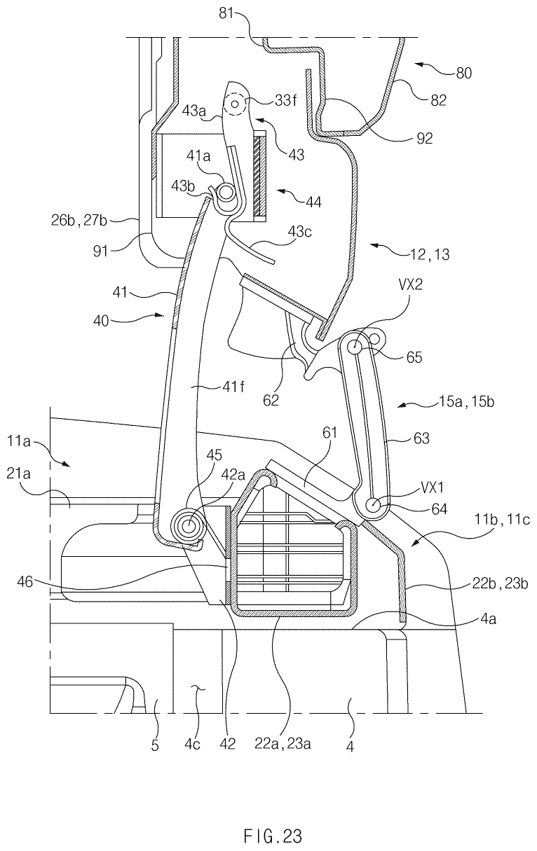

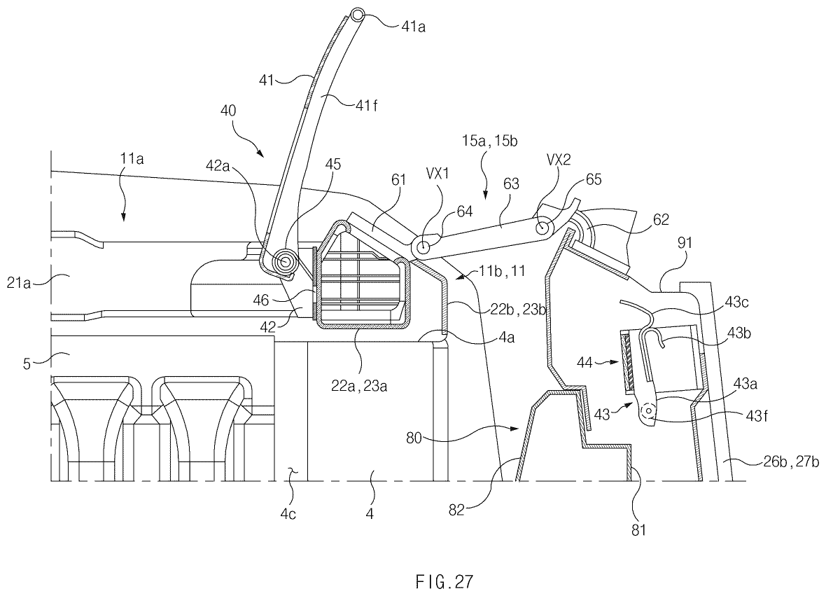

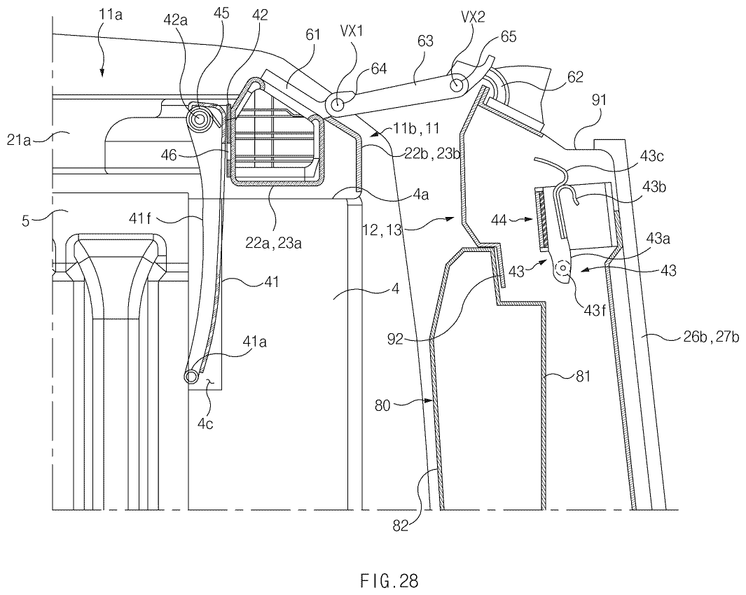

The check strip 41 may be pivotally mounted on a check bracket 42 through a pivot pin 42a, and the check bracket 42 may be fixed to each of the side members 22a and 23a of the side portions 11b and 11c of the main frame 11 through a fastener. The check strip 41 may be configured to move between an unfolded position (see FIGS. 23 and 27) in which the check strip 41 is unfolded from the check bracket 42 toward the outside of the vehicle body 2 and a folded position (see FIG. 28) in which the check strip 41 is folded to the check bracket 42. When the check strip 41 is in the unfolded position, the check strip 41 may be open wide with respect to the check bracket 42 at a predetermined angle, and when the check strip 41 is in the folded position, the check strip 41 may be overlapped with the check bracket 42. The check strip 41 may be biased to the unfolded position by a torsion spring 45, and the torsion spring 45 may be disposed around the pivot pin 42a. Each of the doors 12 and 13 may have a side opening 91 which is open to the corresponding one of the side portions 11b and 11c of the main frame 11. As the doors 12 and 13 move between the closed position, the first open position, and the second open position, the check strip 41 may be received in the inside of each of the doors 12 and 13 or be released from the inside of each of the doors 12 and 13 through the side opening 91 of each of the doors 12 and 13. Referring to FIG. 21, when each of the doors 12 and 13 is in the closed position, the check strip 41 may be completely received in the inside of each of the doors 12 and 13. Referring to FIGS. 22 to 26, while each of the doors 12 and 13 is moving from the closed position to the first open position, the check strip 41 may be partially released from the inside of each of the doors 12 and 13. Referring to FIGS. 27 and 28, when each of the doors 12 and 13 is in the second open position, the check strip 41 may be completely released from the inside of each of the doors 12 and 13.

The check strip 41 may be curved, and the check strip 41 may have a pair of sidewalls 41f provided at both edges thereof. The check strip 41 may have a first end portion pivotally mounted on the check bracket 42, and a second end portion located opposite to the first end portion. The check strip 41 may have a coupling pin 41a provided on the second end portion, and the coupling pin 41a may connect the pair of sidewalls 41f.

Referring to FIG. 21, the stopper 43 may be mounted in the inside of each of the doors 12 and 13 through an inner bracket 44. The inner bracket 44 may include a flange 44b fixed to the interior surface of each of the doors 12 and 13 through a plurality of fasteners, and a mounting wall 44a located opposite to the flange 44b.

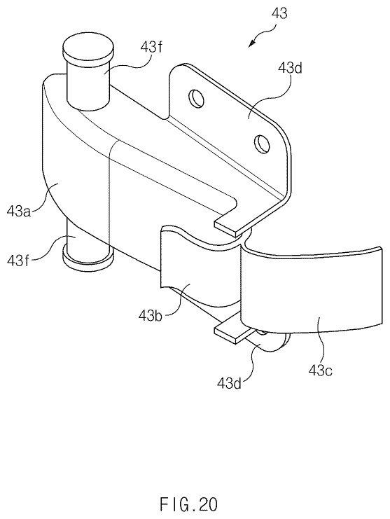

Referring to FIG. 20, the stopper 43 may include a body 43a, and a hook 43b provided on the body 43a. The body 43a may have two flanges 43d, and the two flanges 43d may be fixed to the mounting wall 44a of the inner bracket 44 through a plurality of fasteners. The hook 43b may have a cavity in which the coupling pin 41a of the check strip 41 can be received, and the coupling pin 41a of the check strip 41 may be coupled to or separated from the hook 43b of the stopper 43. When the coupling pin 41a of the check strip 41 is coupled to or separated from the hook 43b, the hook 43b may be elastically deformable. The stopper 43 may have a restore guide 43c extending from the hook 43b toward the corresponding one of the side hinges 15a and 15b, and the restore guide 43c may be curved. The restore guide 43c may be configured to guide the coupling pin 41a of the check strip 41 to the hook 43b of the stopper 43. The stopper 43 may have a pair of guide projections 43f protruding from both sides of the body 43a, and the pair of guide projections 43f may be configured to guide the pair of sidewalls 41f of the check strip 41. When each of the doors 12 and 13 moves to the first open position, the pair of guide projections 43f may guide the pair of sidewalls 41f of the check strip 41 to move the coupling pin 41a of the check strip 41 to the hook 43b of the stopper 43.

Referring to FIG. 28, each sidewall 4 of the vehicle body 2 may have a recessed portion 4c which is recessed from the interior surface of the sidewall 4 toward the exterior surface of the sidewall 4, and the recessed portion 4c of the sidewall 4 may be aligned with the check bracket 42. When the check strip 41 is in the folded position, the recessed portion 4c may be configured to receive the check strip 41. As the check strip 41 completely released from each of the doors 12 and 13 is folded by the user in a direction opposite to a direction in which the check strip 41 is biased by the torsion spring 45, the check strip 41 may be folded to the check bracket 42. Accordingly, the check strip 41 may be folded toward the interior surface of the corresponding sidewall 4 so that the check strip 41 may be received in the recessed portion 4c of the sidewall 4.

The door check mechanism 40 may further include a retainer configured to retain the check strip 41 in the folded position, and the retainer may be configured to keep the check strip 41 in a state of being folded to the check bracket 42. The check strip 41 completely released from each of the doors 12 and 13 may be kept in a state of being received in the recessed portion 4c of the corresponding sidewall 4 by the retainer.

A folding sensor 46 may be mounted on the check bracket 42, and a folding sensor 46 may be configured to detect that the check strip 41 is in the folded position. Accordingly, the folding sensor 46 may detect the folded state of the check strip 41 with respect to the check bracket 42. When the check strip 41 is in the folded position, the check strip 41 may be received in the recessed portion 4c of the corresponding sidewall 4. In this state, when the main frame 11 of the tailgate 10 is opened in the first mode, there may be a risk of malfunction of the tailgate 10 and/or damage to the check strip 41. The folding sensor 46 may detect that the check strip 41 is in the folded position, and the controller 150 may determine that the check strip 41 is received in the recessed portion 4c of the sidewall 4 based on the detection result of the folding sensor 46, and accordingly the controller 150 may block the tailgate 10 from being closed, thereby preventing damage to the check strip 41. When the user moves the check strip 41 to the unfolded position, the check strip 41 may be released from the recessed portion 4c of the sidewall 4. As each of the doors 12 and 13 moves from the second open position to the first open position, the check strip 41 may be received in the inside of each of the doors 12 and 13 through the side opening 91 of each of the doors 12 and 13.

Referring to FIG. 21, when each of the doors 12 and 13 is in the closed position, the check strip 41 may be completely received in the inside of each of the doors 12 and 13 through the side opening 91 of each of the doors 12 and 13. As the check strip 41 received in the inside of each of the doors 12 and 13 comes into contact with the stopper 43, the check strip 41 may be parallel to each of the doors 12 and 13.

Referring to FIG. 22, when each of the doors 12 and 13 is opened, each of the doors 12 and 13 and the hinge arm 63 of each of the side hinges 15a and 15b may pivot around the first vertical axis VX1, and the check strip 41 of the door check mechanism 40 may pivot along a direction in which each of the doors 12 and 13 is opened so that the check strip 41 may be partially released from each of the doors 12 and 13 through the side opening 91.

Referring to FIG. 23, when each of the doors 12 and 13 is in the first open position, the coupling pin 41a of the check strip 41 may be coupled to the hook 43b of the stopper 43 so that the check strip 41 may be coupled to the stopper 43, and accordingly each of the doors 12 and 13 may be held in the first open position.

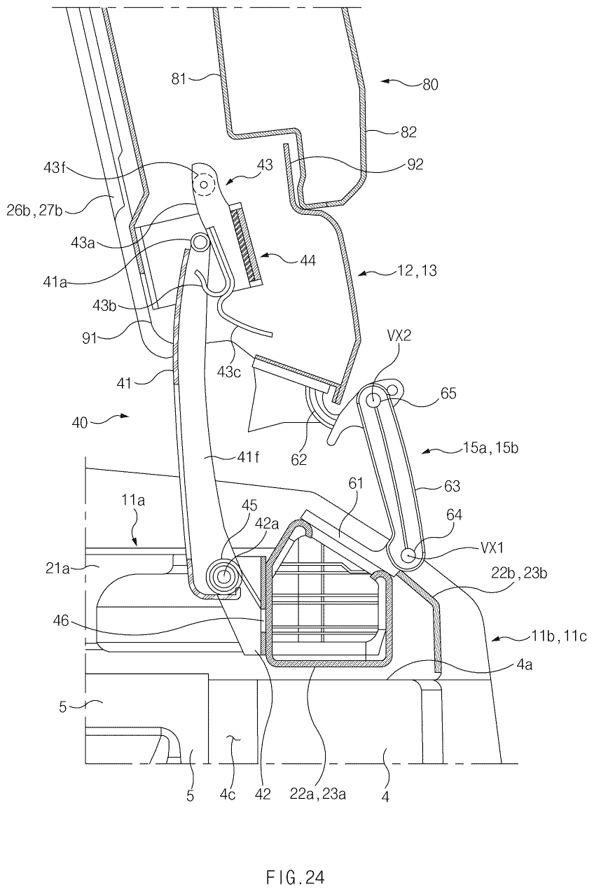

Referring to FIG. 24, when each of the doors 12 and 13 pivots from the first open position to the closed position at a predetermined angle, the coupling pin 41a of the check strip 41 may be separated from the hook 43b of the stopper 43 so that the check strip 41 may be released from the stopper 43.

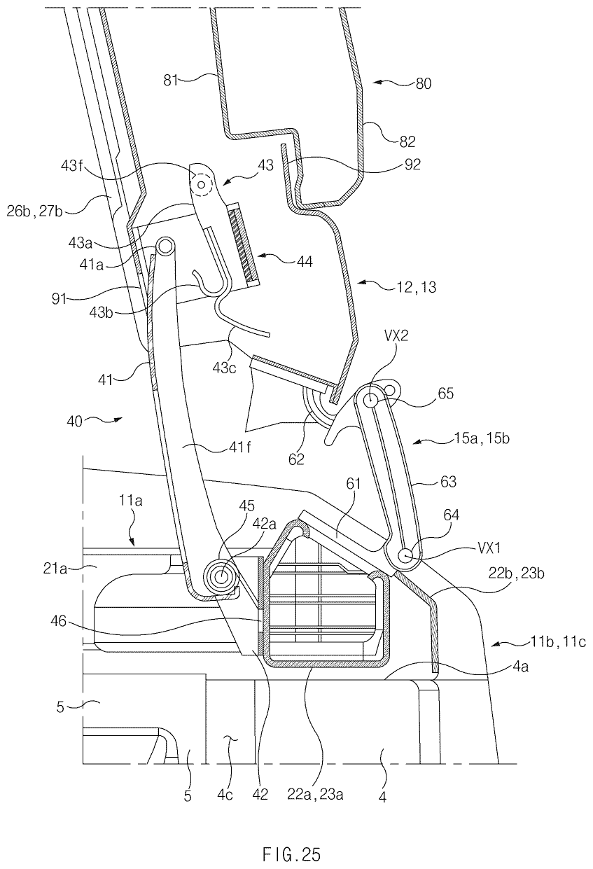

Referring to FIG. 25, when the check strip 41 pivots slightly toward the closed position of each of the doors 12 and 13, the check strip 41 may be partially released from each of the doors 12 and 13 through the side opening 91 of each of the doors 12 and 13.

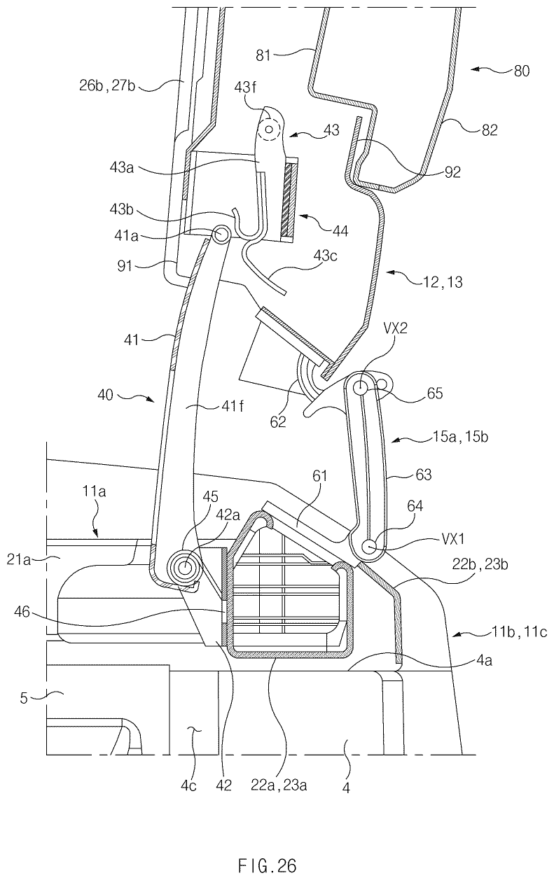

Referring to FIG. 26, as each of the doors 12 and 13 moves back to the first open position, the coupling pin 41a of the check strip 41 may be completely separated from the hook 43b of the stopper 43 so that the check strip 41 may be completely released from the stopper 43.

Referring to FIG. 27, as the check strip 41 is completely released from the stopper 43, each of the doors 12 and 13 may be allowed to move from the first open position to the second open position, and the check strip 41 may be completely released from each of the doors 12 and 13.

Referring to FIG. 28, as the check strip 41 is folded to the check bracket 42, the check strip 41 may be folded toward the corresponding sidewall 4 of the vehicle body 2, and the check strip 41 may be received in the recessed portion 4c of the sidewall 4. The check strip 41 may be kept in a state of being received in the recessed portion 4c of the sidewall 4 by the retainer provided on the check bracket 42.

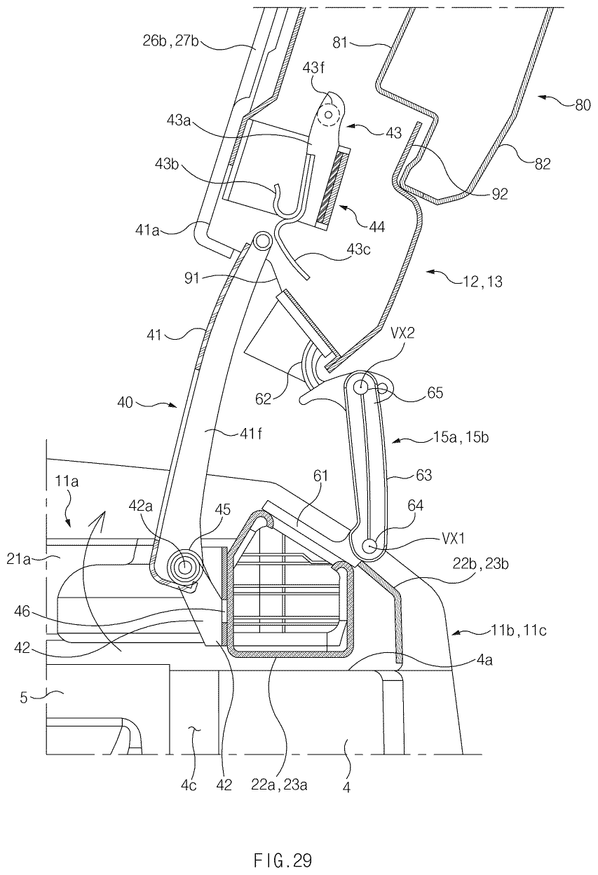

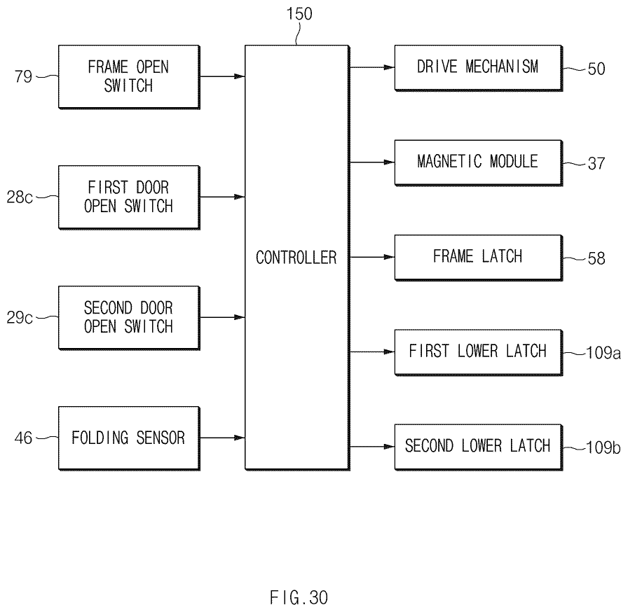

Referring to FIG. 29, as each of the doors 12 and 13 moves from the second open position to the first open position, and the check strip 41 pivots toward each of the doors 12 and 13, the check strip 41 may be received in the inside of each of the doors 12 and 13 through the side opening 91 of each of the doors 12 and 13, and the coupling pin 41a of the check strip 41 may be guided to the hook 43b of the stopper 43 by the restore guide 43c of the stopper 43. When each of the doors 12 and 13 completely moves from the second open position to the first open position, the coupling pin 41a of the check strip 41 may be recoupled to the hook 43b of the stopper 43 (see FIG. 23). Then, as each of the doors 12 and 13 moves from the first open position to the closed position, the coupling pin 41a of the check strip 41 may come into contact with the stopper 43 in the inside of each of the doors 12 and 13 so that the check strip 41 may be parallel to each of the doors 12 and 13 (see FIG. 21).

Referring to FIG. 1, the tailgate apparatus 100 according to an example embodiment of the present disclosure may include a step mechanism 80 configured to be stowed in and deployed from the tailgate 10 when the tailgate 10 is opened and closed. The step mechanism 80 may be configured to be stowed in and deployed from at least one of the first door 12 and the second door 13 of the tailgate 10.

Referring to FIG. 1, in a state in which the tailgate 10 is in the closed position, the step mechanism 80 may be stowed in the first door 12 of the tailgate 10. Referring to FIG. 5, in a state in which the tailgate 10 is in the open position, the step mechanism 80 may be deployed from the first door 12 of the tailgate 10. Accordingly, it may be easy for the user to get on and off the luggage compartment 3 of the vehicle body 2 through the step mechanism 80.

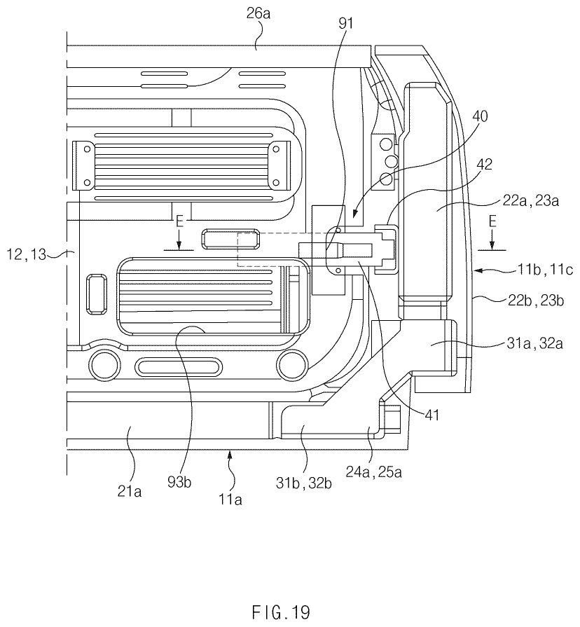

Referring to FIG. 6, the first door 12 may have an accommodating opening 93a provided in the exterior surface thereof. The step mechanism 80 may be stowed in the accommodating opening 93a of the first door 12 or deployed from the accommodating opening 93a of the first door 12. The first door 12 may have a recessed wall 92 which is recessed from the exterior surface thereof toward the interior surface. When the step mechanism 80 is received in the accommodating opening 93a of the first door 12, the step mechanism 80 may be supported by the recessed wall 92. The accommodating opening 93a may be formed in the middle of the recessed wall 92. Referring to FIG. 19, the first door 12 may have a through hole 93b provided in the interior surface thereof, and the through hole 93b may be aligned with the accommodating opening 93a. A relatively long object such as a ski may extend through the accommodating opening 93a and the through hole 93b. Referring to FIG. 21, the step mechanism 80 may include a step body 81 received in the tailgate 10, and a cover body 82 covering the step body 81.

FIG. 30 illustrates the controller 150 and components connected thereto in the vehicle tailgate apparatus according to an example embodiment of the present disclosure.

The frame open switch 79, the first door open switch 28c, the second door open switch 29c, the folding sensor 46, the drive mechanism 50, and the frame latch 58 may be electrically connected to the controller 150. The controller 150 may receive a signal from the frame open switch 79, the first door open switch 28c, the second door open switch 29c, the folding sensor 46, and/or the like, and control the operation of the frame latch 58 and the operation of the drive mechanism 50 based on the signal. The frame latch 58 may be configured to allow the main frame 11 of the tailgate 10 to be locked to and unlocked from the sidewall 4 of the vehicle body 2. When the user presses the frame open switch 79, a turn-on signal of the frame open switch 79 may be transmitted to the controller 150, and the controller 150 may control the operation of the frame latch 58 and the operation of the drive mechanism 50 so that the main frame 11 may be opened and closed.

The first door open switch 28c, the second door open switch 29c, the first lower latch 109a, the second lower latch 109b, and the magnetic module 37 may be electrically connected to the controller 150. As the first lower latch 109a locks and unlocks the first lower striker 19a, the first lower latch 109a may be configured to allow the first door 12 to be locked to and unlocked from the main frame 11, and as the second lower latch 109b locks and unlocks the second lower striker 19b, the second lower latch 109b may be configured to allow the second door 13 to be locked to and unlocked from the main frame 11. As the magnetic module 37 locks and unlocks the contact module 38, the magnetic module 37 may be configured to allow the first door 12 and the second door 13 to be locked to and unlocked from each other. When the user presses the first door open switch 28c, a turn-on signal of the first door open switch 28c may be transmitted to the controller 150, and the controller 150 may control the operation of the first lower latch 109a and the operation of the magnetic module 37, and accordingly the user may manually open and close the first door 12. When the user presses the second door open switch 29c, a turn-on signal of the second door open switch 29c may be transmitted to the controller 150, and the controller 150 may control the operation of the second lower latch 109b and the operation of the magnetic module 37, and accordingly the user may manually open and close the second door 13.

As set forth above, according to example embodiments of the present disclosure, the main frame of the tailgate may be aligned with the pair of sidewalls and the bed of the vehicle body so that the main frame may not interfere with the luggage compartment when the tailgate is opened in the drop-down manner. Accordingly, the width of the main frame may be maximized to correspond to the width of the vehicle body, and the width of the luggage compartment may be relatively increased. That is, when the tailgate is opened in the drop-down manner, the opening width (or opening area) of the luggage compartment may be maximized.

According to example embodiments of the present disclosure, the doors may be pivotally connected to the corresponding side portions of the main frame through the side hinges, respectively. When each door is opened, the door may move to the first open position and the second open position. In particular, when each door moves to the second open position in which the door is overlapped with the exterior surface of the corresponding sidewall of the vehicle body, the door may not be located behind the rear of the vehicle so that space utilization at the rear of the vehicle may be improved. Specifically, because the door is not located behind the rear of the vehicle in a state in which the door is opened in the second open position, this may be advantageous to luggage loading and unloading, trailer connection, the user's movement, and the like.

According to example embodiments of the present disclosure, the two doors may be configured to open and close simultaneously or independently of each other in a state in which the main frame is in the closed position, and thus the opening and closing of each door may be facilitated.

According to example embodiments of the present disclosure, the frame open switch may be provided on the top surface of each sidewall of the vehicle body, and the door open switch may be provided on the grip of each door so that each open switch may be intuitive to use. Thus, the opening and closing of the tailgate may be facilitated.

According to example embodiments of the present disclosure, each side hinge may use the two vertical axes so that each door may move along the elliptical swing path. Accordingly, the swing path of each door may be relatively compact, which facilitates the opening and closing of the door in a narrow space.

According to example embodiments of the present disclosure, the tailgate apparatus may operate in various modes such as the first mode, the second mode, and the third mode for various purposes, and accordingly usability and convenience thereof may be significantly improved.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. A vehicle tailgate apparatus comprising a tailgate, wherein the tailgate includes a main frame configured to move between an open position and a closed position through a pair of bottom hinges at a rear end of a luggage compartment of a vehicle body, wherein at least part of the luggage compartment is defined by interior surfaces of a pair of sidewalls and a bed of the vehicle body,
wherein the main frame includes a bottom portion, a first side portion extending from a first end of the bottom portion, and a second side portion extending from a second end of the bottom portion,
wherein each of the first side portion and the second side portion is aligned with a corresponding sidewall of the pair of sidewalls, respectively,
wherein the tailgate is configured such that while the main frame is in the closed position, the first side portion of the main frame and the second side portion of the main frame both cover at least a portion of a corresponding rear facing end exterior surface of the pair of sidewalls, respectively, and
wherein the bottom portion of the main frame is aligned with the bed.

2. The vehicle tailgate apparatus of claim 1, wherein an exterior surface of each of the first side portion and the second side portion includes an exterior side portion surface that is aligned with an exterior sidewall surface of the corresponding sidewall of the pair of sidewalls, respectively.

3. The vehicle tailgate apparatus of claim 1, wherein both ends of the bottom portion are pivotally connected to the pair of sidewalls by the pair of bottom hinges, and
each of the pair of bottom hinges has a horizontal axis extending in a width direction of the vehicle body.

4. The vehicle tailgate apparatus of claim 1, wherein each of the pair of bottom hinges is mounted between a corresponding sidewall of the vehicle body and a corresponding end of the bottom portion, and
wherein each of the pair of bottom hinges is aligned with a bottom end of a corresponding side portion.

5. The vehicle tailgate apparatus of claim 1, wherein the main frame includes a wiring path therein.

6. The vehicle tailgate apparatus of claim 1, wherein the main frame further includes a first connection member connecting the first end of the bottom portion and a first bottom end of the first side portion, and a second connection member connecting the second end of the bottom portion and a second bottom end of the second side portion.

7. The vehicle tailgate apparatus of claim 6, wherein the first connection member and the second connection member are made of a material different from those of the bottom portion, the first side portion, and the second side portion.

8. A vehicle tailgate apparatus comprising a tailgate, wherein the tailgate comprises:
a main frame configured to move between an open position and a closed position through a pair of bottom hinges at a rear end of a luggage compartment of a vehicle body, wherein at least part of the luggage compartment is defined by interior surfaces of a pair of sidewalls and a bed of the vehicle body,
wherein the main frame includes a bottom portion, a first side portion extending from a first end of the bottom portion, and a second side portion extending from a second end of the bottom portion,
wherein the tailgate is configured such that while the main frame is in the closed position, the first side portion of the main frame and the second side portion of the main frame each cover a corresponding rear facing end exterior surface of the pair of sidewalls, respectively; and
a pair of doors including a first door and a second door, wherein the first door is pivotally connected to the first side portion of the main frame by a first side hinge, wherein the second door is pivotally connected to the second side portion of the main frame by a second side hinge, and wherein the pair of doors are disposed in an opening defined by the bottom portion, the first side portion, and the second side portion of the main frame.

9. The apparatus of claim 8, wherein each of the first side hinge and the second side hinge is configured to pivot about a first vertical axis adjacent to one of the pair of sidewalls of the vehicle body,
wherein each of the first side hinge and the second side hinge is also configured to pivot about a second vertical axis adjacent to one of the pair of doors, and
wherein the second vertical axis is parallel to the first vertical axis.

10. The apparatus of claim 9, wherein each of the pair of doors is configured to move between a closed position, a first open position, and a second open position,
wherein in the first open position, at least one of the pair of doors is aligned with a corresponding sidewall of the pair of sidewalls in a longitudinal direction of the vehicle body, and
wherein in the second open position, at least one of the pair of doors is folded toward a side exterior surface of the corresponding sidewall of the pair of sidewalls.

11. The apparatus of claim 9, wherein each of the first side hinge and the second side hinge includes a frame-side hinge bracket mounted on each of the first side portion and the second side portion, respectively, of the main frame,
wherein each of the first side hinge and the second side hinge includes a door-side hinge bracket mounted on each of the first door and the second door, respectively, and
wherein each of the first side hinge and the second side hinge includes a hinge arm pivotally connected to the frame-side hinge bracket and the door-side hinge bracket.

12. The apparatus of claim 11, wherein each of the first side portion and the second side portion includes a side member,
wherein a lower end portion of the side member is received in an upper receiving portion of a corresponding connection member, and
wherein the frame-side hinge bracket and the upper receiving portion of the corresponding connection member are fixed to the lower end portion of the side member using a fastener.

13. The apparatus of claim 10, further comprising a door check mechanism configured to hold one of the pair of doors in the first open position or allow the one of the pair of doors to move to the second open position.

14. The apparatus of claim 13, wherein the door check mechanism includes:
a check strip pivotally connected to one of the first side portion or the second side portion of the main frame; and
a stopper located inside of the one of the pair of doors, wherein the check strip and the stopper are configured to be releasably coupled together.

15. The apparatus of claim 14, wherein the one of the pair of doors has a side opening that opens to the one of the first side portion or the second side portion of the main frame, and
wherein the one of the pair of doors is configured such that when the one of the pair of doors moves between the closed position, the first open position, and the second open position, the check strip is received inside of the side opening or is released from inside of the side opening.

16. The apparatus of claim 15, wherein one of the pair of sidewalls of the vehicle body has a recessed portion in which the check strip can be received.

17. The apparatus of claim 8, further comprising a magnetic module and a contact module provided between facing edges of the pair of doors, wherein the magnetic module and the contact module are configured such that as the magnetic module generates a magnetic field, the contact module is attached to the magnetic module, and as the magnetic module blocks the magnetic field, the contact module is not attached to the magnetic module.

18. The apparatus of claim 17, wherein the contact module includes a contact plate configured to attach to the magnetic module by the magnetic field generated by the magnetic module,
wherein the contact plate is configured to move between an attachment position in which the contact plate is attached to the magnetic module and a detachment position in which the contact plate is detached and spaced apart from the magnetic module, and
wherein the contact module further includes a biasing member, wherein the biasing member is configured to bias the contact plate toward the detachment position.

19. A vehicle tailgate apparatus comprising:
a tailgate, wherein the tailgate includes a main frame having a bottom portion, and a pair of side portions extending from both ends of the bottom portion, respectively, wherein at least part of a luggage compartment is defined by interior surfaces of a pair of sidewalls and a bed of a vehicle body, wherein the pair of side portions of the main frame are aligned with corresponding outside surfaces of the pair of sidewalls of the vehicle body, respectively, and
wherein the tailgate is configured such that while the main frame is in a closed position, the pair of side portions of the main frame both cover a corresponding rear facing end exterior surface of the pair of sidewalls, respectively;
a frame latch provided on one of the corresponding rear facing end exterior surface of the pair of sidewalls of the vehicle body; and
a frame striker provided on one of the pair of side portions of the main frame, wherein the frame striker is configured to engage the frame latch such that the main frame can be locked to and unlocked from the one of the corresponding rear facing end exterior surface of the pair of sidewalls of the vehicle body by the frame latch and the frame striker.

20. The apparatus of claim 19, wherein each of the pair of side portions comprises:
a side member having a cavity therein; and
a side molding attached to a side member exterior surface of the side member.
